(19) United States
(12) Patent Application Publication
(10) Pub. No.: US 2013/0091019 A1
(43) Pub. Date: Apr. 11, 2013

(54) System for Serving Advertisements

(71) Applicants: Kenneth P. Mallon, Foster City, CA (US); Randolph Preston McAfee, San Marino, CA (US)

(72) Inventors: Kenneth P. Mallon, Foster City, CA (US); Randolph Preston McAfee, San Marino, CA (US)

(73) Assignee: Yahoo! Inc., Sunnyvale, CA (US)

(21) Appl. No.: 13/253,650

(22) Filed: Oct. 5, 2011

(51) Int. Cl. G06Q 30/02

(52) U.S. Cl. 705/14.68; 705/14.69

(57) ABSTRACT

A computer-implemented method serves advertisements. The method includes identifying a first advertising opportunity for a user. The advertising opportunity includes an opportunity to display an advertisement to the user. A threshold exposure value is determined. The advertisement is served to the user during the first advertising opportunity. An exposure duration is tracked through the use of at least one processor. The exposure duration represents a total length of time that the advertisement is displayed to the user. The exposure duration is compared to the threshold exposure value. A second advertising opportunity for the user is identified. The method also includes serving the advertisement to the user during the second advertising opportunity when the exposure duration is less than the threshold exposure value, and not serving the advertisement to the user during the second advertising opportunity when the exposure duration is not less than the threshold exposure value.

### TECHNICAL FIELD

The present description relates generally to a system and method, generally referred to as a system, for serving advertisements.

### BACKGROUND

A market exists for the distribution of advertising and other information over data communications and entertainment networks. A non-limiting example is insertion of advertising copy supplied by advertisers, for appearance on web pages, content offered by media distributors such as news and information services, internet service providers, and suppliers of products related to the advertiser's products or services.

Despite the current economic forecasts, the surge in marketing budgets being diverted into digital media continues unfettered. Digital media offers marketers a rapid, highly targeted, interactive, measurable and cost effective route to target consumers, something that may become even more important in times of uncertainty. With huge volumes of webpages being created daily, bringing with them a similar surge of new inventory, online publishers may seek to maximize their yields right across their properties by monetizing both their premium and unsold inventory. At the same time, the inventory may help online advertisers' source new opportunities to target their audience.

This growth is taking place in an environment of continuing media and audience fragmentation. However, it is the increasing complexities of reaching audiences that has driven the emergence of online advertising exchanges to provide efficiencies and reduce the complexities in an incredibly dynamic environment. Hundreds of millions of websites and huge volumes of online advertising are communicated around the world every day.

### SUMMARY

A computer-implemented method serves advertisements. The method includes identifying a first advertising opportunity for a user. The advertising opportunity includes an opportunity to display an advertisement to the user. A threshold exposure value is determined. The advertisement is served to the user during the first advertising opportunity. An exposure duration is tracked through the use of at least one processor. The exposure duration represents a total length of time that the advertisement is displayed to the user. The exposure duration is compared to the threshold exposure value. A second advertising opportunity for the user is identified. The method also includes serving the advertisement to the user during the second advertising opportunity when the exposure duration is less than the threshold exposure value, and not serving the advertisement to the user during the second advertising opportunity when the exposure duration is not less than the threshold exposure value.

Other systems, methods, features and advantages will be, or will become, apparent to one with skill in the art upon examination of the following Figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the Figures are not necessarily to scale, emphasis instead being placed upon illustrating principles. In the Figures, like referenced numerals may refer to like parts throughout the different Figures unless otherwise specified.

FIG. 1 is a block diagram of a general overview of a network environment and system for distributing advertisements.

FIG. 2 is a block diagram of an exemplary network environment and architecture for an advertising system.

FIG. 3 is a flow chart of a method for serving advertisements.

FIG. 4 is a flow chart of a method for serving advertisements.

FIG. 5 is a flow chart of a method for serving advertisements.

FIG. 6 is a screen shot of a web page with an advertisement displayed.

FIG. 7 is a graph summarizing experimental results for recognition and recall rates.

FIG. 8 is a graph summarizing experimental results for recall rates.

FIG. 9 is a graph summarizing experimental results for recognition rates.

FIG. 10 is a graph summarizing experimental results for recognition and recall rates.

FIG. 11 is a graph summarizing experimental results for recall rates.

FIG. 12 is a graph summarizing experimental results for recognition rates.

FIG. 13 is a graph summarizing experimental results for recognition and recall rates.

FIG. 14 is a graph summarizing experimental results for recognition and recall rates.

FIG. 15 is a flow chart illustrating a method of pricing advertising duration units.

FIG. 16 is a block diagram of an exemplary processing system for executing advertisement impression distribution systems and methods.

### DETAILED DESCRIPTION

Display advertising is a multi-billion dollar industry that generates revenue from advertisers paying to place graphical advertisements on a content provider's website. Many display advertising systems operate with a pricing scheme based on the number of impressions delivered, or the number of downloads of an advertisement. In some of these systems, ad impressions may be sold to advertisers in guaranteed contracts, which may specify a number of impressions and a set of targeting variables. For example, an advertiser may negotiate to purchase 10 million advertisement impressions on auto-related pages sold to women between 30 and 50 years of age, or 7 million impressions targeted to people interested in women's fashion. In addition, display ads may also be sold in exchanges, such as Yahoo!'s Right Media exchange (RMX). In such exchanges, display ads may be individually targeted to specific users, and when a user clicks on a page, the exchange may sell the right to show an ad to that particular user as that page loads.

Internet display ads may be priced on an impression basis largely for historic reasons, as charging based on a number of impressions was familiar to advertisers who bought newspapers advertising. However, the widespread adoption of web technologies such as AJAX may make the practice of tying impressions to the loading of a page less reliable or obsolete. For example, popular email programs like Yahoo! Mail may update content as new mail comes in without any action by the user. In this dynamic setting, a web browser may remain on one URL or page, even where the entire content of that page may be changed at any given time. In these environments, it may become unclear what it means for a page to be replaced, and consequently when an advertisement should be replaced by a subsequent advertisement, because content is replaced in an approximately continuous manner. One ad impression may be in view for five seconds or five minutes, depending on the type of web page displaying the impression and/or the user's habits when interacting with the web page and/or impression.

Since advertisers seek brand recognition and recall, a system utilizing or incorporating a time-based accounting and capitalizing on a relationship between ad exposure time and a probability that a viewer will remember or recognize an advertisement may align with advertisers' goals.

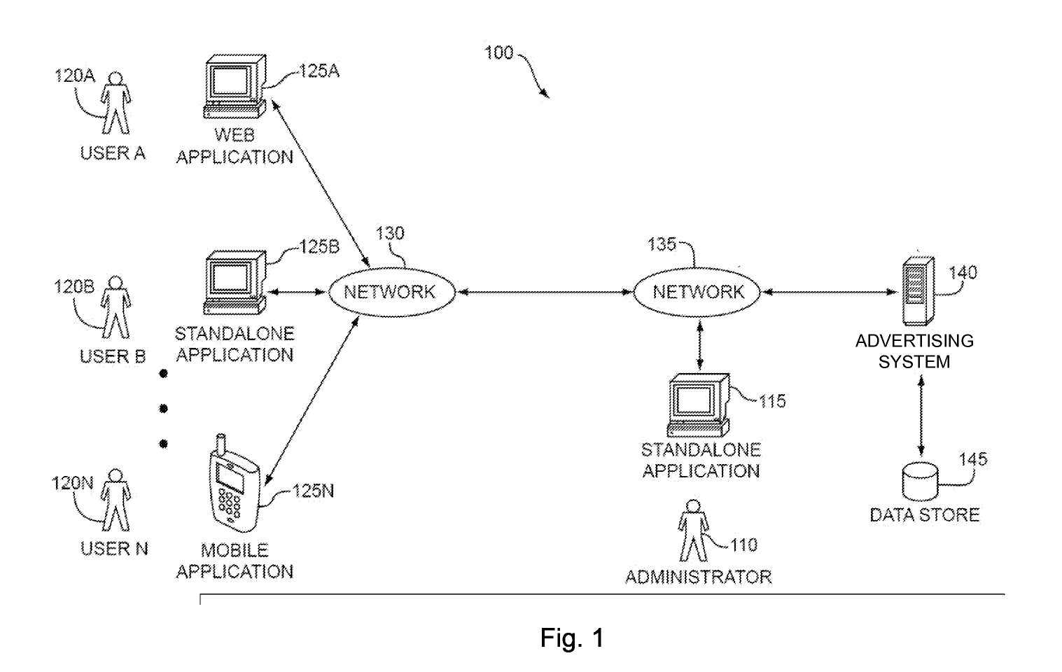

FIG. 1 provides a simplified view of a network environment 100 for serving advertisements to one or more users and/or managing advertising campaigns. Not all of the depicted components may be required, however, and some implementations may include additional components not shown in the Figure. Variations in the arrangement and type of the components may be made without departing from the spirit or scope of the claims as set forth herein. Additional, different or fewer components may be provided.

The network environment 100 may include an administrator 110 and one or more users 120A-120N with access to one or more networks 130, 135, and one or more web applications, standalone applications, mobile applications 115, 125A-125N, which may collectively be referred to as client applications. The network environment 100 may also include one or more advertisement systems 140 and related data stores 145. The users 120A-120N may request pages, such as web pages, via the web application, standalone application, mobile application 125A-125N, such as web browsers. The requested page may request an advertisement impression from the advertisement server 140 to fill a space on the page.

The advertising system 140 may serve one or more advertisement impressions to the pages. The advertisement impressions may include online graphical advertisements, such as in a unified marketplace for graphical advertisement impressions. Advertising impressions and/or advertisements may be served to a user each time an advertising impression opportunity (“ad opportunity”) arises. For example, variable banner ads may be inserted into web pages that are transmitted to users. Alternatively and/or in addition, an advertisement or advertiser listing may be inserted into a list of results returned in response to a user search query. Alternatively and/or in addition, for example, an advertisement or advertiser listing may be inserted when a user is playing a game on a web site, a mobile phone, or a smart phone. Alternatively and/or in addition, an advertisement or advertiser listing may be inserted when a user is using an application on a web site, on a mobile phone, or on a smart phone. Ad opportunities may arise anytime a user visits a page, enters a search query, plays a game on a website or phone, uses an application on a website or phone, or uses a search engine. For example, every web site view may be an ad opportunity.

Advertisements (“ads”) may be allocated selectively, based on characteristics of the user or typical users of the particular web page, or otherwise selected to match user and content information, location, timing and other criteria to advertiser specifications, for targeting the ads to potential customers.

Some or all of the advertising system 140 and the one or more web applications, standalone application, mobile applications 115, 125A-125N, may be in communication with each other by way of the networks 130 and 135. The networks 130, 135 may be configured to couple one computing device to another computing device to enable communication of data between the devices. The networks 130, 135 may generally be enabled to employ any form of machine-readable media for communicating information from one device to another. The networks 130, 135 may include wide area networks (WAN), such as the Internet, local area networks (LAN), campus area networks, metropolitan area networks, wireless networks, wired networks, a direct connection such as through a Universal Serial Bus (USB) port, or any other networks that may allow for data communication. The network 130 may include the Internet and may include all or part of network 135; network 135 may include all or part of network 130. The networks 130, 135 may be divided into sub-networks. The sub-networks may allow access to all of the other components connected to the networks 130, 135 in the system 100, or the sub-networks may restrict access between the components connected to the networks 130, 135. The network 135 may be regarded as a public or private network connection and may include, for example, a virtual private network or an encryption or other security mechanism employed over the public Internet, or the like.

The web applications, standalone applications and mobile applications 115, 125A-125N may be connected to the network 130 in any configuration that supports data transfer. This may include a data connection to the network 130 that may be wired or wireless. Any of the web applications, standalone applications and mobile applications 115, 125A-125N may individually be referred to as a client application.

The web application 125A may run on any platform that supports web content, such as a web browser or a computer, a mobile phone, personal digital assistant (PDA), pager, network-enabled television, digital video recorder, such as TIVO®, automobile and/or any appliance or platform capable of data communications.

The standalone application 125B may run on a machine that includes a processor, memory, a display, a user interface and a communication interface. The processor may be operatively connected to the memory, display and the interfaces and may perform tasks at the request of the standalone application 125B or the underlying operating system. The memory may be capable of storing data. The display may be operatively connected to the memory and the processor and may be capable of displaying information to the user B 125B. The user interface may be operatively connected to the memory, the processor, and the display and may be capable of interacting with a user B 120B. The communication interface may be operatively connected to the memory, and the processor, and may be capable of communicating through the networks 130, 135 with the advertising system 140. The standalone application 125B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 125N may run on any mobile device that may have a data connection. The data connection may be a cellular connection, a wireless data connection, an internet connection, an infra-red connection, a Bluetooth connection, or any other connection capable of transmitting data. For example, the mobile application 125N may be an application running on an APPLE IPHONE®.

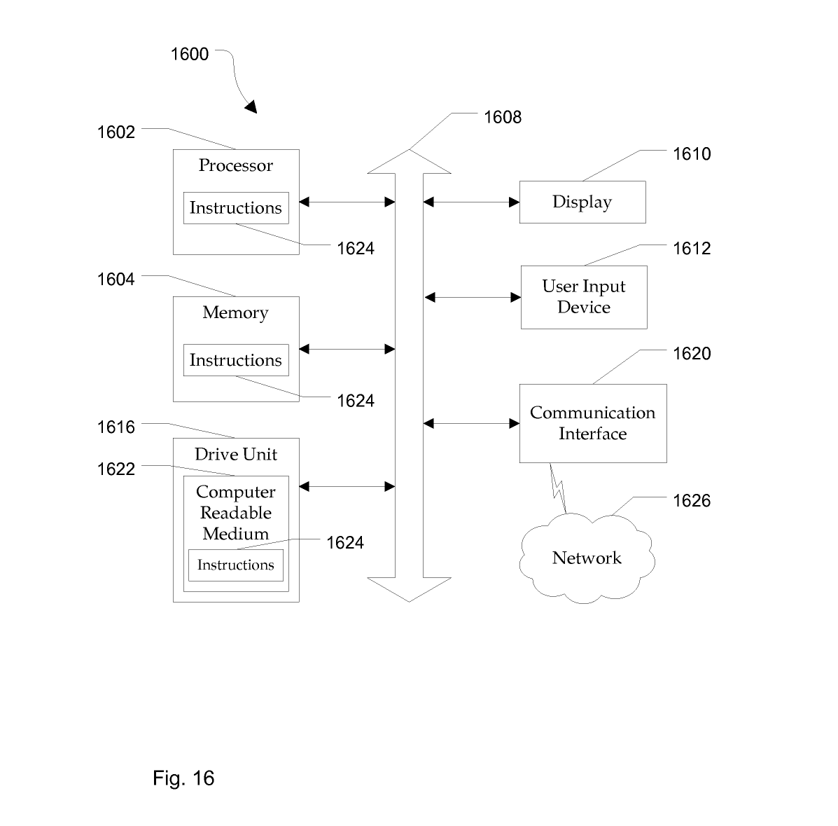

The advertising system 140 and/or data store 145 may exist on one machine or may be running in a distributed configuration on one or more machines. There may be several configurations of database servers, application servers, mobile application servers, and middleware applications included in the advertising system 140 and/or data store 145. The data store 145 may or may not be part of the advertising system 140, and may or may not be a database server, such as MICROSOFT SQL SERVER®, ORACLE®, IBM DB2®, SQLITE®, or any other database software, relational or otherwise. The application server may be APACHE TOMCAT®, MICROSOFT IIS®, ADOBE COLDFUSION®, or any other application server that supports communication protocols. The advertising system 140, data store 145, and/or client applications 115, 125A-125N may each be or include one or more computing devices of various kinds, such as the computing device described below in conjunction with FIG. 16. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 125A may employ the Hypertext Transfer Protocol (“HTTP”) to request information, such as a web page, from a web server, which may be a process executing on the advertising system 140.

The advertising system 140 may be automated or may be controlled manually. The advertising system 140 may in some systems be controlled by a content provider, an online provider, and/or a digital content or media provider, such as a content provider providing or in communication with a provider providing the requested web page to a user. Various other configurations are possible.

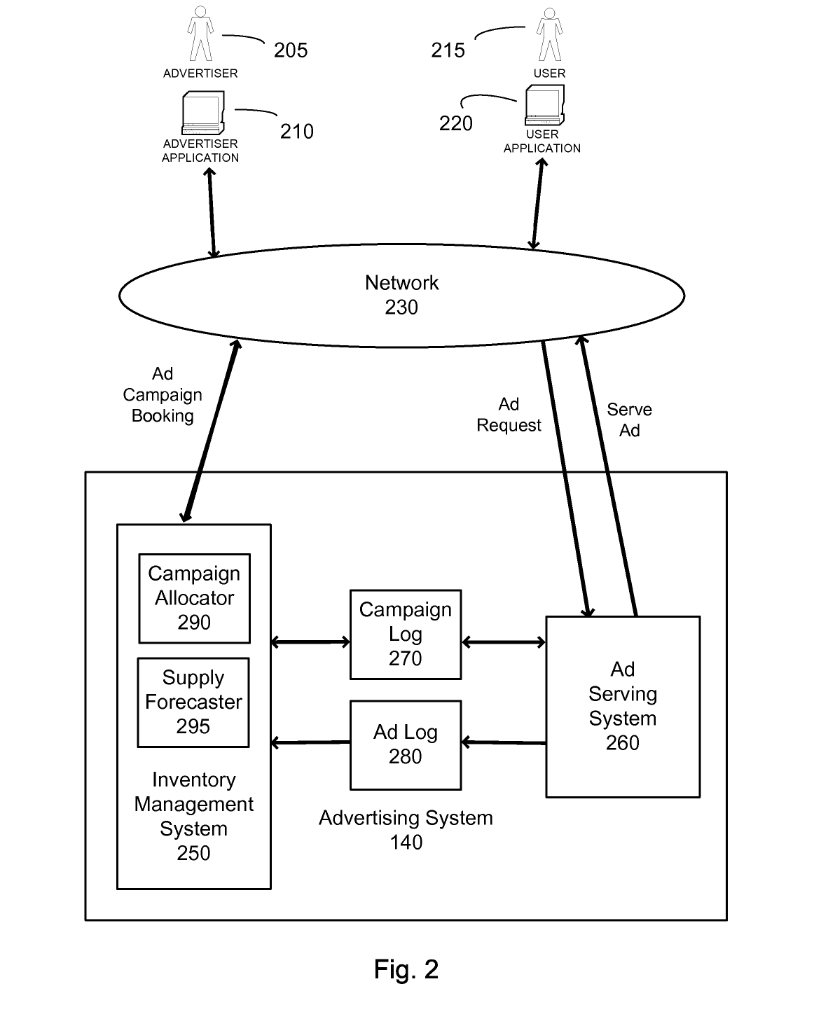

The advertising system 140 may be in communication with the client applications 115, 125A-125N, such as over the networks 130, 135. For example, the advertising system 140 may provide an interface to the users 120A-120N through the client applications 125A-125N, such as a user interface for inputting search requests, managing an email account, and/or viewing web pages. Alternatively or in addition, the advertising system 140 may provide a user interface to the administrator 110 via the client application 115, such as a user interface for managing the data source 145 and/or configuring advertisements. The users 120A-120N may include advertisers, such as advertiser 205 shown in FIG. 2, and users, such as user 215 shown in FIG. 2.

FIG. 2 is a block diagram of an exemplary network environment with an advertising system 140. The advertising system 140 may be connected to one or more networks such as network 230, which may be, include, or otherwise resemble either or both of networks 130 and 135 in FIG. 1. Network 230 may be connected or otherwise in communication with the advertiser 205, the advertiser application 210, the user 215, the user application 220, the advertising system 140, and/or any of the components of the advertising system 140. For illustrative purposes, network 230 is shown as one network, but network 230 may be a plurality of networks which may all be the same or different. Networks 130, 135, 230, and 1626 may include different networks connected together or all part of the same network, or any combination thereof.

A user 215 may, for example, be any of the users 120A-120N (FIG. 1). The user 215 may interact with the advertising system 140, such as through the use of a user application 220. The user application 220 may, for example, be a web application 125A, a standalone application 125B, a mobile application 125N, or any other application which may allow the user 215 to view and/or interact with the network 235 and/or the advertising system 140.

The user 215 may be involved in, for example, viewing a web page, searching for information using a search engine, viewing a display, or otherwise gathering information. The user 215 may or may not be aware of the advertising system 140 or any of its components.

An advertiser 205 may, for example, be any of the users 120A-120N. The advertiser 205 may interact with the advertising system 140, such as through the use of an advertiser application 210. The advertiser application 210 may, for example, be a web application 125A, a standalone application 125B, a mobile application 125N, or any other application which may allow the advertiser 205 to view and/or interact with the network 230 and/or the advertising system 140.

The advertiser 205 may be involved or interested in, for example, disseminating information. The advertiser 205 may advertise the advertiser's businesses, products, or services. The advertiser 205 may, alternatively or additionally, wish to disseminate other information about the advertiser 205 or other information. For example, the advertiser 205 may be an airport or airline and may wish to disseminate information about flights. An advertiser 205 may include any individual, group of individuals, or entity that wishes to communicate or otherwise distribute information to another individual, group of individuals, or entities.

Advertisements may include any information which an entity wishes to be disseminated to another. For example, advertisements may include information for or about an entity, product, or service. Alternatively or in addition, advertisements may include any other information, messages, data, or otherwise that an entity wishes to convey. Advertisers 205 may be any individual, group of individuals, or entity which wishes to convey or disseminate any information, message, data, or otherwise to another.

The advertising system 140 may include an ad serving system 260, a campaign log 270, an ad log 280, an inventory management system 250, a campaign allocator 290, and a supply forecaster 295. In some systems, one or more of these components of the advertising system 140 may be consolidated into one component and/or may not be included or necessary. In some systems, the advertising system 140 may include additional components.

The advertising system 140 may create, manage, store, provide an interface for, assist with, control, and/or otherwise handle one or more advertising campaigns (ad campaigns) associated with advertisers 205. Additionally or alternatively, the advertising system 140 may manage, assist in, and/or control the display of advertisements and/or other information to a user 215 when the user 215 seeks information, such as, for example, by visiting a web page or entering a query using a search engine.

An advertiser 205 may wish to target advertisements or information to a particular user or type of user, during a particular time period, and/or in a particular manner. Ad campaigns may be created and/or managed at the advertiser's request and/or direction to accomplish some or all of the advertiser's goals. The purpose of an ad campaign may be to organize and/or simplify the efforts of the advertiser 205 and to allow the advertiser 205 to target advertisements and information to users as desired. The advertising system 140 and/or one or more components of the advertising system 140, such as the inventory management system 250, the campaign allocator 290, and/or the supply forecaster 295 may be associated with the creation and/or management of ad campaigns.

In creating an ad campaign, an advertiser 205 may identify or specify one or more requirements or features of an ad campaign. An advertiser 205 may, for example, specify a budget, total spend, or other economic requirement of the ad campaign. Economic requirements may be identified and/or specified for each advertisement and/or advertisement impression, for one or more subsets or group of advertisements and/or advertisement impressions, and/or for the entire ad campaign and/or all advertisements and/or advertisement impressions.

In creating an advertising campaign, an advertiser 205 may specify one or more characteristics and/or user attributes (“attributes”) which the advertiser 205 may desire to be satisfied by each ad impression. Attributes and attribute types may include, for example, a position of the advertisement, a content topic of the page or display, a gender of the potential viewer or user viewing the advertisement, an age or age category of the potential viewer, a location of the advertisement, a location of the potential viewer, an age of the viewer, characteristics of the viewer, and/or a behavior tag. Attribute types may also or alternatively include, for example, a device identifier (such as a user or device specific identification number or name) or device type (such as an iPad, mobile phone, laptop, etc.) on which a user is viewing content. Attribute types may also or alternatively include, for example, a time of day, day of the week, and/or other timing information for the ad impression. Attribute types may specify or clarify one or more of characteristics of an ad opportunity or display, such as who may view an advertisement and what is the viewer interested in or is the content of the opportunity and/or type of advertisement to fill it. In addition, attributes may specify or clarify when, where, and how an advertisement may be displayed to fill the ad opportunity. Any number of attribute types may exist.

For example, the advertiser 205 may wish to serve its advertisements only to males of a first age category in the state of California, and therefore may specify the attributes of male and California when creating the ad campaign. Alternatively, the advertiser may wish to serve its advertisements to females under the age of 16 or over the age of 50 in any one of one thousand zipcodes, and may specify female, 16 and under or over 50, and the thousand zipcodes as attributes when creating the ad campaign. Various other examples are possible.

In creating an advertising campaign, an advertiser 205 may also or alternatively specify and/or purchase ad impressions in various ways. For example, an advertiser 205 may specify and/or express a desire to purchase one or more advertisement impressions, irrespective of a duration or anticipated effectiveness of the impression.

In some systems, the advertiser 205 may also or alternatively specify a duration requirement, which may identify a length of time that an advertiser may wish to show or display an advertisement to a user. The duration requirement may be satisfied by tracking a display time of an advertisement over one impression or a combination of impressions to a user. In these systems, the advertiser 205 may specify or purchase a length of time for which an advertisement will be displayed to a user, regardless of whether or not that length of time is achieved in one or multiple advertising impressions.

Additionally or alternatively, the advertiser 205 may specify a placement requirement related to a placement and/or order of placement of an advertisement during an ad opportunity. For example, the advertiser 205 may specify that they only want their advertisements to be displayed during an initial period of an advertising opportunity for a user. As another example, the advertiser 205 may specify that they only want their advertisements to be displayed after at least 20 seconds of the ad opportunity have elapsed. In the latter example, the advertising system 140 may maximize revenue by, for example, displaying a different advertisement for a different advertiser during a first portion of the ad opportunity, and later switching the displayed advertisement to the advertiser 205's advertisement after 20 seconds have elapsed, provided the ad opportunity lasts that long.

In some systems, an advertiser 205 may specify and/or express an impact requirement which may be identify or specify a desired impact of an impression, such as achieve a desired, estimated, projected, and/or historical recognition and/or recall rate for the user who viewed the advertisement, that the advertiser may desire to achieve with an advertisement impression. In some of these systems, the advertising system 140 may gather and analyze the requested impact requirement, and determine a length of exposure and/or order or placement of an advertisement which may achieve the desired impact, as described below. Various other examples are possible.

The campaign requirements and/or specified desires of the advertiser 205 may include one or more requirements and/or attributes together in a consolidated and/or combined requirement. For example, an advertiser 205 may contact an advertising system 140 and request an ad campaign where the advertiser 205 will designate a total spend of $1 million and wishes to have the advertiser's advertisement shown only to males of a first age category. As another example, impact requirements may be tied to other requirements, such as economic requirements and/or order of placement requirements. For example, an advertiser 205 may specify a requirement that the advertiser will pay $0.01 for each 10 second interval of an impression, up to and until the expected recall rate of the user drops below 20% per 10 seconds of the impression. As another example, an advertiser may set up an advertising campaign where the advertiser will designate that they wish to have the advertiser's advertisement shown to 100,000 males of a first age category for at least a time period equal to a target recall or target recognition rate. Various other configurations and arrangements are possible.

The advertising system 140 and/or one or more components of the advertising system 140, such as an inventory management system 250 and/or supply forecaster 295, may receive the requirements and/or attributes from the advertiser 205. The advertising system 140, inventory management system 250, and/or supply forecaster 295 and may estimate, generate, determine, predict, forecast, and/or otherwise identify a supply of ad opportunities that the advertising system 140 may anticipate being available for the ad campaign of the advertiser 205.

Due to the nature of online advertising, the advertiser 205 may not have a hard and fast, or otherwise permanent, set of advertising opportunities which are known and certain to take place in the future. Rather, the advertising system 140, inventory management system 250, and/or supply forecaster 295 may look to data about previous advertising impressions, such as data stored in an ad log 280 or other memory or database, in order to forecast, estimate, and/or predict the number of similar advertising opportunities likely to occur in the future. An ad log 280 may, for example, store past and/or historical data, such as data and attribute information about each ad impression for the advertising system 140. Such data may, for example, include a record of some or all ad impressions made on any particular system and/or over any particular time period, and may further include attribute information about the characteristics of the viewer of the advertisement impression, as well as the timing, placement, surrounding content, or other information about the ad impression. For example, the ad log 280 may include information about who viewed an advertisement impression, as well as how long the impression was displayed to the user. The advertising system 140, inventory management system 250, and/or supply forecaster 295 may compare historical data from the ad log 280 with the attributes or ad campaign requirements of the advertiser 205. An ad impression may match or qualify as relevant for a campaign when the attribute of its attribute type satisfies the conditions specified by the campaign. In some embodiments, an ad impression may match or be relevant if all of the attributes specified by the advertiser 205 are the same as the ad impression.

Based on the forecasted supply, the advertising system 140, inventory management system 250, and/or campaign allocator 290 determine how much of the supply may be allocated, if booked or reserved, to an ad campaign requested by the advertiser 205. Information on other ad campaigns previously booked or reserved may be stored and/or accessed, for example, by one or more campaign logs 270. In determining how much supply may be allocated, the advertising system 140, inventory management system 250, and/or campaign allocator 290 may consult or otherwise communicate with the campaign log 270 to gather, consider, and/or analyze information pertaining to other campaigns. Based on this information, the advertising system 140 may determine a supply which may be allocated to the advertiser 205, and an ad campaign for the advertiser 205 may be created, booked, and/or otherwise reserved.

As mentioned, the advertising system 140 may also manage, assist in, and/or control the display of advertisements and/or other information to a user 215 when the user 215 seeks information, such as, for example, by visiting a web page or entering a query using a search engine.

When a user, such as user 215 in FIG. 2, enters a search request, visits a web site, or otherwise generates an advertising opportunity, the advertising system 140 and/or ad serving system 260 may receive a request for an advertisement. The advertising system 140 and/or ad serving system 260 may gather information about the ad opportunity, such as the type of audience, the timing, the available space of an advertisement, etc., and may communicate with the campaign log 270 to identify an advertising campaign which meets the criteria of the advertising opportunity. An advertisement may be chosen from one or more ad campaigns which meet the criteria of the ad opportunity. For example, an ad campaign with attributes which match the ad opportunity may be selected. The chosen advertisement from the selected ad campaign may be sent from the campaign log 270 to the ad serving system 260, and then to the user 215 or the user application 220. Alternatively, the advertisement may be sent directly from the campaign log 270 to the user 215 or the user application 220. The ad serving system 260 may then record the service of the advertisement in the ad log 280, as well as other data regarding this advertisement opportunity and impression, for use with future advertising campaign booking requests or inquiries.

Advertising systems 140 and/or advertiser 205 may benefit from an awareness of an amount of time an advertisement is displayed to a user 215. For example, as described later, the amount of time that an advertisement is displayed to a user 215 may directly affect a recall and/or recognition that the user 215 may have for content and/or advertisements that they were exposed to. Accordingly, in order to achieve high rates of return-on-investment and/or maximize efficiency of an advertising campaign and/or budget associated with an advertising campaign, one or more systems or methods which track cumulative time that an advertisement may be served to a user over one or more advertising impressions or opportunities may prove highly beneficial to both advertisers 205 and advertising systems 140.

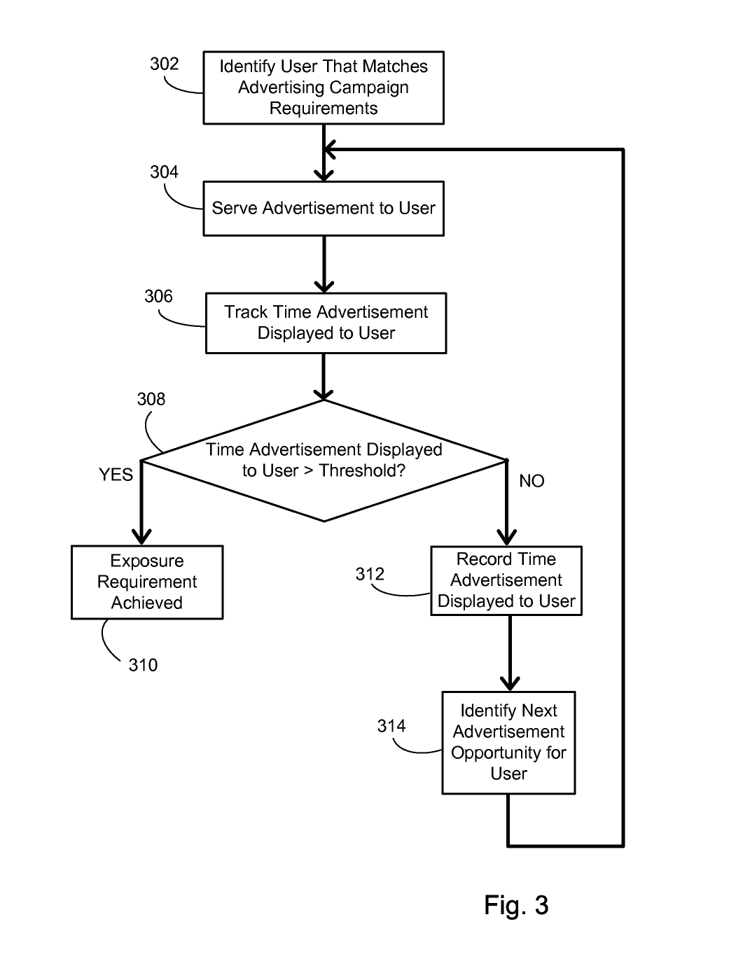

FIG. 3 illustrates a method for managing an advertising campaign and serving advertisements to a user in an impression-based environment according to one or more impact requirements.

The method may begin at block 302, where a user 215 is identified that matches the advertising campaign requirements of an advertiser 205. In some systems, the user may 215 be specifically identified by the advertiser 205 when creating the advertising campaign. In other systems, the user 215 may be any user 215 that matches the requirements of the advertising campaign. In some of these systems, the user 215 may be identified upon an identification or determination by the advertising system 140 that an advertising opportunity may arise for the user 215. For example, where an advertising campaign may seek to target males in California, the advertising system 140 may merely monitor advertising opportunities and, when an opportunity arises for a user fitting the requirements, that user may be identified at block 302 and served an advertisement 304. In other systems, users 215 may be identified at various other times and in various other ways.

When an advertising opportunity arises for the user 215, the method may proceed to block 304, where the advertisement for the advertiser 205 may be served to the user 215. The advertising opportunity may arise, for example, when the user 215 enters a search query or views a web page that includes time and/or space for an advertisement, or at various other times and in various other ways.

At block 306, a duration or amount of time that the advertisement is displayed to the user 215 (which may also be referred to as an exposure time, advertisement display time, and/or exposure duration) may be tracked. The amount of time a user 215 spends on a page may be quite variable. The duration of the exposure of the advertisement to the user 215 may be tracked, for example, by the advertising system 140, the content provider or advertiser 205.

Tracking the time an advertisement is in front of the user 215 may be accomplished in various ways. For example, the advertising system 140 may incorporate and/or use a Javascript code or php code to track the amount of time a page is open or remains in focus. For example, a Javascript code may be included which may send a ping back to a server or to the advertising system 140 ever 1/10^{th} of a second. Various other examples are possible.

At block 308, the tracked time that the advertisement was displayed to the user 215 may be compared to a threshold. The threshold may represent or correspond to a threshold amount of time which may be required to satisfy one or more requirements, such as an exposure requirement, of the advertising campaign. For example, the threshold may represent or correspond to an advertising campaign exposure requirement explicitly specified by the advertiser 205 when creating the ad campaign that each user views an advertisement for a certain period of time. In other systems, the threshold may have been calculated, suggested, or otherwise determined by the advertising system 140.

In some systems, the threshold may represent, relate to, and/or otherwise correspond to an exposure requirement identified, determined, and/or calculated to achieve an estimated recall rate or recognition rate for the user 215. In these systems, the threshold may, for example, be calculated, suggested, and/or otherwise determined by the advertising system 140, such as based on an expected and/or desired recall rate or recognition rate specified or identified by the advertiser 205 when creating the ad campaign, as described later. Various other examples are possible.

Where the time the advertisement is displayed to the user 215 is greater than the threshold, the method may proceed to block 310, where the exposure requirement of the advertiser 205 is determined to be achieved.

Though not shown, in some systems, after block 310, the user 215 may not be served the advertisement for the advertiser 205 in subsequent ad opportunities arising for the user 215, as the desired exposure for the user 215 may have already been achieved. For example, a cookie may be created for the user 215 noting that the user has already seen the advertisement for the desired exposure time, such when an advertising opportunity for the user arises in the future, the advertising system 140 and/or the advertiser 205 will read and/or interpret the cookie and accordingly not serve the same advertisement to the user 215. As another example, the advertising system 140 and/or advertiser 205 may record the IP address of the user 215 and associate the IP address with a user who has already seen the advertisement for the desired exposure time, such that when an advertising opportunity for the user 215 arises in the future, the advertising system 140 and/or the advertiser 205 will compare the IP address of the user with those IP addresses of users who have already seen the advertisement for the desired exposure time and accordingly not serve the same advertisement to the user.

In some systems, after block 310, the advertising system 140 and/or advertiser 205 may never serve the user 215 with the same advertisement again. In other systems, the advertising system 140 and/or advertiser 205 may identify a period of time with which to treat the user 215 as having viewed the advertisement for the desired exposure time, after which the user 215 may be treated as not having viewed the advertisements. Such a system may be used, for example, where it is assumed that a user 215 will remember an advertisement for a certain time period, but eventually forget the advertisement. In these systems, the period of time with which the user 215 is treated as having viewed the advertisement may correspond to the estimated time that it may be assumed that the user 215 will remember the advertisement, or may be calculated in various other ways. In still other systems, after block 310, the user 215 may merely be treated as a user who has not viewed the advertisement, such that when an advertisement opportunities arises for the user 215, the advertising system 140 and/or advertiser 205 may identify the user 215 and/or serve an advertisement to the user in blocks 302 and 304 as if the user had not previously viewed the advertisement. Various other examples are possible.

Returning to block 308, where the time the advertisement is displayed to the user 215 is not greater than the threshold, the method may proceed to block 312, where the time the advertisement is displayed to the user may be recorded. Recording the time the advertisement was displayed to the user may be accomplished in various ways. For example, the advertising system 140 may write into a cookie the amount of time that the advertisement is displayed to the user. As another example, the advertising system 140 may observe the IP address of the user and associate the IP address with the amount of time the advertisement is displayed to the user.

From block 312, the method may proceed to block 314 where the next advertisement opportunity for the user 215 may be identified. The advertising system 140 may monitor when an advertising opportunity for the user 215 occurs, and may serve the same advertisement for the advertiser 205 to the user during this advertisement opportunity at block 304. In identifying the advertising opportunity in block 314, the advertising system 140 may, for example, monitor all advertising opportunities, and may note via monitored cookies or IP addresses when the same user 215 has created and/or is associated with an advertising opportunity.

Once the same user 215 has been identified and served the same advertisement in block 304, the method may proceed as described above. The tracked time that the advertisement was displayed to the user in block 306 may include the total tracked time that the advertisement was displayed to the user 215 during all advertisement opportunities for the user 215. In this way, the cumulative tracked time the advertisement was displayed to the user 215 may be compared to the threshold value in block 308. Various other examples are possible.

In some systems, one or more of the blocks of the method in FIG. 3 may be rearranged and/or take place in a different order. For example, in some systems, block 312 may be implemented in conjunction with block 306 and/or before block 308. In these systems, the time that an advertisement is displayed to a user may be recorded before any comparison. Various other examples are possible.

An advertiser 205 and/or advertising system 140 may be able to incorporate and/or use these methods to keep track of an amount of time a user is exposed to an advertisement. Where the threshold his calculated using estimated recall or recognition rates, as described later, the advertiser 205 and/or advertising system 140 may be able to tailor an advertising campaign in such a way as to maximize an effectiveness of the advertising campaign by serving advertisements to users to achieve optimal recall rates and/or recognition rates per budget and/or expense. The use of the methods in FIG. 3 may allow advertisers and/or advertising systems 140 to allocate and/or purchase advertising opportunities or advertising impressions for targeted users to achieve high recall and recognition rates.

The method of FIG. 3 may be useful in an impression-based system for transacting advertising opportunities and/or impressions. The method may allow for management of an impression-based advertising campaign with a time-based awareness. In these transactional systems, the method may be used to alert and/or automate the purchasing of advertising impressions by an advertising system 140 and/or advertiser 205 to serve to a user 215 an advertisement for a preferring and/or desired period of time. In these systems, where user 215 is served an advertisement and does not view it for the desired time, additional advertisement impressions for this same user 215 may be purchased by the same advertiser 205 until the user 215 has viewed the advertisement for the desired length of time.

As a numerical example of the method in FIG. 3 in an impression-based transactional advertising system, consider where an advertiser 205 has identified as an ad campaign requirement a desired estimated recall rate of 50% for each user viewing the advertisement of the advertiser 205, as well as various geographical and user characteristic requirements. The advertising system 140 and/or the advertiser 205, through any of the methods or formulas presented herein, may identify an exposure time of 40 seconds as corresponding to the desired estimated recall rate specified by the advertiser 205. This exposure time of 40 seconds may represent the threshold.

A first user 215 associated with an advertising opportunity and who meets the advertiser's various geographical and user characteristic requirements may be identified and served the advertisement. The amount of time the advertisement is displayed being monitored. The user may only view the advertisement for 15 seconds before closing the window or being directed away from the advertisement. In this case, the tracked time may be 15 seconds, and the method may proceed to blocks 310 and 312 as the advertisement was not displayed to the user for more than 40 seconds. When a second advertisement opportunity for this same user is later identified, the advertisement may again be served to the user. During the second advertisement opportunity, the user may view the advertisement for 20 seconds before closing the window or being directed away from the advertisement. Now, in block 306, the tracked time may be 15 seconds+20 seconds=35 seconds. As the exposure time of 35 seconds is still less than the threshold of 40 seconds, the method may proceed to blocks 310 and 312. When a third advertisement opportunity for this same user is later identified, the advertisement may again be served to the user. During the third advertisement opportunity, the user may view the advertisement for 25 seconds before closing the window or being directed away from the advertisement. Now, in block 306, the tracked time may be 15 seconds+20 seconds+25 seconds=60 seconds. As this is greater than the threshold of 40 seconds, the method may proceed to block 310, and the exposure requirement for this user may be treated as achieved.

The method of FIG. 3 may also be used in a time-based system for transacting advertising opportunities and/or impressions. In these transactional systems, the method may be used to alert and/or automate the purchasing of more advertising time by an advertising system 140 and/or advertiser 205 to serve to a user 215 an advertisement for a preferring and/or desired period of time. In these systems, where user 215 is served an advertisement and does not view it for the desired time, additional time for this same user 215 may be purchased by the same advertiser 205 until the user 215 has viewed the advertisement for the desired length of time.

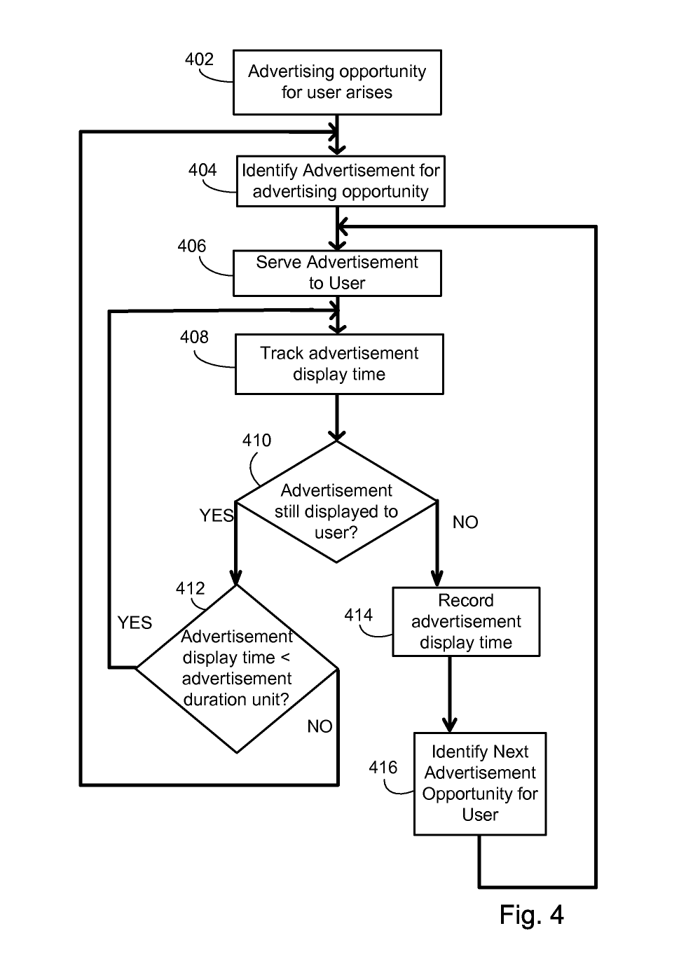

In some of these systems where advertisement opportunities are transacted and/or parsed based partially or exclusively on an amount of time that an advertisement may be displayed, one or more additional or alternative methods may be useful in limiting costs to an advertiser 205, maximizing advertising opportunities or revenue for advertising systems 140 and/or content providers, and/or for increasing a recall and/or recognition rate for users. FIG. 4 depicts an alternative method which may be used for serving advertisements. The method of FIG. 4 may be particularly useful in a time-based system for transacting advertising opportunities and/or impressions.

The method may begin at block 402, where an advertising opportunity for a user 215 may arise. This may occur, for example, when a user 215 requests a web page that includes a space for an advertisement. Various other examples are possible.

At block 404, an ad campaign and/or advertiser 205 who is targeting a user with the characteristics of the user 215 may be identified. For example, where an advertiser 205 has created an ad campaign targeting males from California less than 30 years old, and where user 215 meets these criteria, the advertiser 205 may be identified. Additionally or alternatively, an advertisement associated with the ad campaign and/or advertiser 205 may be identified.

At block 406, the advertisement may be served to the user 215. The advertisement may represent an advertising impression served to fill the ad opportunity that the user has created.

At block 408, the advertisement display time is tracked. The advertisement display time may represent the amount of time that the advertisement has been displayed to the user.

At block 410, a determination may be made as to whether or not the advertisement is still displayed to the user. In some systems, this may be a continuous determination, or may be performed at various intervals, such as every 1/10^{th} of a second or longer. In some systems, this determination may also be expressed as a determination as to whether or not the ad opportunity is still open and/or exists for the user 215.

If the advertisement is still displayed to the user, the method may proceed to block 412, where a determination may be made as to whether or not the advertisement display time is less than an advertisement duration unit. An advertisement duration unit may represent the amount of time that the advertiser may have purchased for each ad impression. For example, an advertiser 205 may have purchased 1 million ad impressions of 30 seconds in duration. In this example, the advertisement duration unit may be 30 seconds. In some systems, as described below the advertisement duration unit may be tied to recall or recognition rates for the user or for similar users, and/or may be priced by the advertising system 140 accordingly.

Where the advertisement display time is less than the advertisement duration unit, the method may return to block 408. Blocks 408, 410, and 412 may continue in a continuous loop until either the advertisement is no longer displayed to the user or until the advertisement display time is equal to or greater than the advertisement duration unit.

At block 412, if the determination indicates that the advertisement display time is not less than the advertisement duration unit, it can be assumed that the advertisement duration unit has been achieved. In this situation, as the advertisement was still displayed to the user, it can also be assumed that the ad opportunity still exists. In this situation, the method may proceed back to block 404, where a new advertisement, ad campaign, and/or advertiser 205 may be identified and another advertisement served in place of the first advertisement.

An advertising system 140 may achieve the result of displaying two advertisements back to back in the same ad opportunity in a number of ways. For example, the advertising system 140 may code a new advertisement which may display the first advertisement that may run for a first period of time, after which the second advertisement will run. The new advertisement can be created as a .gif file, a flash advertisement, or various other advertisements, and may be run as the only advertisement for an ad opportunity, effectively showing two advertisements. In other systems, code and/or software may be developed which may perform one or more of these functions.

Returning to block 410, if the advertisement is not still displayed to the user, the method may proceed to block 414. In block 414, the advertisement display time may be recorded. This may be similar to or the same as block 312 in FIG. 3.

After block 414, the method may proceed to block 416, where the next ad opportunity for the user is identified, after which the method may proceed to block 406. This block 414 may be similar to or the same as block 314 of FIG. 3.

The method of FIG. 4 may be useful in limiting the costs to the advertiser 205 to only the cost of achieving the targeted threshold amount of exposure time to the user. Additionally, the advertising system 140 may benefit from this method in that another advertisement for a different advertising campaign and/or advertiser 205 may be served in place of the advertisement which may be removed, thereby providing additional revenue to the advertising system 140 and/or content provider. This alternative method may be useful in both time-based and impression-based advertising transactions. Various other examples are possible.

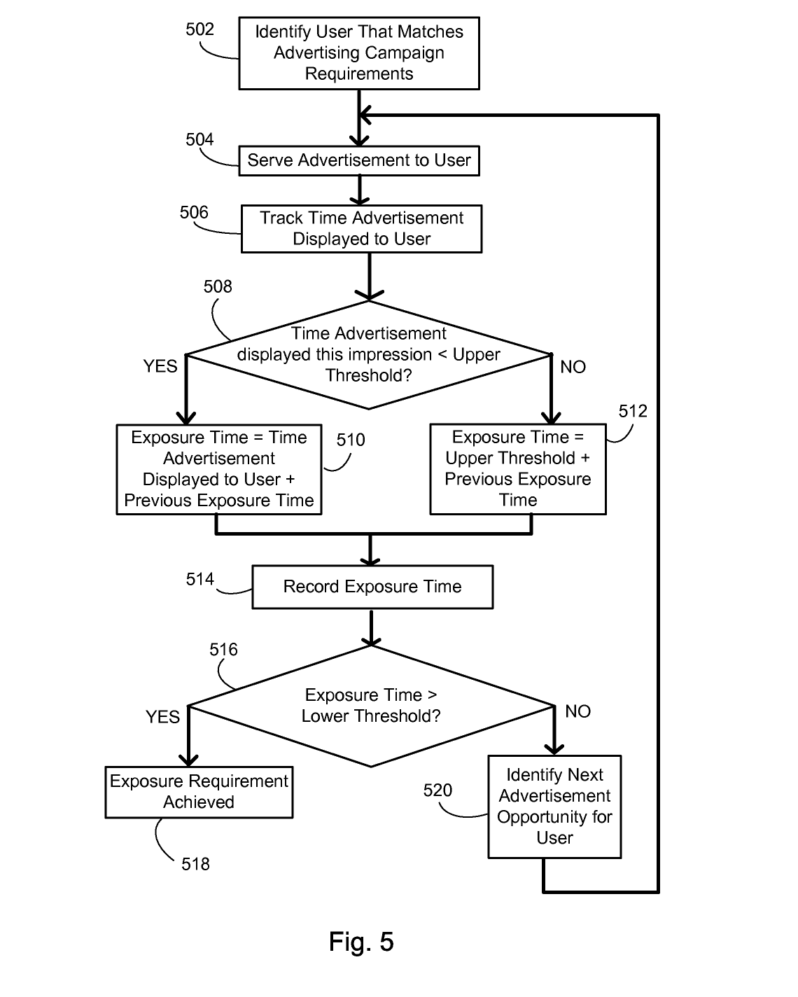

FIG. 5 illustrates another example of a method for managing an advertising campaign and serving advertisements to a user in an impression-based environment according to one or more impact requirements.

The method may begin at block 502, where a user is identified that matches advertising campaign requirements. Block 502 may be the same as or resemble block 302 of FIG. 3.

After block 502, the method may proceed to block 504, where an advertisement may be served to the user. Block 504 may be the same as or resemble block 304 of FIG. 3.

After block 504, the method may proceed to block 506, where the time the advertisement is displayed to the user may be tracked. The time of display to the user may be tracked in one or more of the ways in which time is tracked in block 306 of FIG. 3.

After block 506, the method may proceed to block 508, where the time the advertisement is displayed during the present impression to the user may be compared to an upper threshold value. Time on a page may need or benefit from a cap. A person who spends 24 hours on a single page does not produce 9,000 times as much recall as a person spending ten seconds. Theoretically, the right metric may be one that most closely approximates advertiser value, because this may induce an efficient use of resources. The upper threshold value may be or represent a maximum amount of time for which the advertiser 205 and/or the advertising system 140 may wish to keep track of time for the user. This maximum time may represent a maximum time through which results, such as recall rates and/or recognition rates, may continue to provide increasing returns to the advertiser 205, after which the gains may be minimal or non-existent. Alternatively or additionally, the upper threshold may represent a maximum time for which it can be assumed that the user may be viewing the content on the page and/or the advertisement, above which it may be assumed that the user is no longer viewing the screen or active on the page. Various other examples are possible.

Where the time the advertisement is displayed for the present impression is less than the upper threshold, the method may proceed to block 510, where the exposure time may be specified as the time the advertisement is displayed for the present impression plus any previous exposure time. Generally, previous exposure time may arise where the method has proceeded through multiple iterations, such that the present impression may represent a second, third, etc impression for the user. Where the impression is the first impression for the user, the exposure time may equal the time the advertisement is displayed to the user for this impression.

Alternatively, at block 508, where the time the advertisement is displayed for the present impression is not less than the upper threshold level, the method may proceed to block 512. At block 512, the exposure time may be specified as the upper threshold plus any previous exposure time.

After blocks 510 or 512, the method may proceed to block 514, where the exposure time may be recorded. The recording of the exposure time in block 514 may be the same as or resemble the recording of time in block 312 of FIG. 3. In some alternatives, different times may be recorded, such as the total time an advertisement is displayed, regardless of the upper limit. In other alternatives, the time may be recorded at different times, such as after block 516. Other variations are possible.

After block 514, the method may proceed to block 516, where the exposure time may be compared to a lower threshold. The comparison in block 516 may be the same as or resemble the comparison in block 308 of FIG. 3. Where the exposure time is greater than the lower threshold, the method may proceed to block 518, where the exposure requirement may be achieved. This may be the same as or resemble block 310 of FIG. 3. Where the exposure time is not greater than the lower threshold, the method may proceed to block 520, where the next advertisement opportunity for the user may be identified and the method may proceed back to block 504. Block 520 may be the same as or resemble block 314 of FIG. 3. The method of FIG. 5 may be used with either an impression-based or a time-based system for transacting advertising opportunities and/or impressions.

The incorporation of an upper threshold such as shown in FIG. 5 may provide various benefits. For example, in a time-based system for transacting advertising opportunities, the upper threshold may be used so that advertisers are not unnecessarily charged for time that a user is not likely viewing the page. In these systems, the advertising system 140 may only charge an advertiser 205 for the display time up to the upper threshold value. In other systems, the upper threshold value may be used for the purpose of identifying a maximal gain for which an advertiser 205 may expect to achieve through a display of an advertisement to the user. Various other examples are possible.

As discussed with the methods in FIGS. 3-5, important criteria for consideration by a content provider operating and/or managing the advertising system 140 and/or for an advertiser 205 may be an expected recall rate or recognition rate of a user. These rates may be used, for example, in determining impact requirements and/or exposure thresholds for users 215. Information and/or data about recall rates may also or alternatively be relevant, for example, for pricing of ad opportunities and expected time slots within ad opportunities, forecasting available supply in light of a requested recall rate, determining a necessary impression length to achieve a desired recall rate, and/or various other reasons. Various other uses are possible.

Recall rates may be, represent, or refer to a user or users' ability, or anticipated ability, recall an advertisement or other display that the user or users have been exposed to without the aid of suggestions as to what the user or users may have been exposed to. Recognition rates may be, represent, or refer to a user or users' ability, or anticipated ability, to recognize an advertisement or other display that the user may have been exposed to, when the user or users have been prompted with suggestions as to what the user or users may have been exposed to. In addition or as alternatives to recall and recognition rates, systems may incorporate and/or use rates and/or metrics that are relevant to each individual advertiser 205. Examples of such other metrics may include a rate of users 215 that may recommend a website, product, or service, or a rate of users that may purchase a product or service. In some systems, the metric which may be relevant to the advertiser 205 may be specified when the advertiser 205 creates an advertising campaign. While any of these rates may be referred to individually herein, it should be appreciated that any references to one of these rates, such as a reference to recall rates, may include and/or be substituted for any other rates. These rates may represent anticipated or estimate rates for users, and/or may be based on historical and/or empirical data collected about one or more users.

Recall rates may be estimated, predicted, determined, calculated, projected, forecasted, and/or otherwise identified for each and/or every individual user 215 in communication with a content provider, advertising system 140, advertiser 205, and/or third party. In addition or alternatively, recall rates may be calculated for one or more subsets of users 215. For example, a recall rate for female electrical engineers who graduated from Harvard between 1980 and 1990 may be calculated. In other systems, a general recall rate may be calculated for all users, or for all users who meet the requirements of an advertising campaign. Various other examples are possible.

Recall rates may be estimated, predicted, determined, calculated, projected, forecasted, and/or otherwise identified by various components and/or entities. For example, the advertising system 140 and/or one or more components of the advertising system 140 may be used to project recall rates for one or more users or groups of users. Alternatively or in addition, an advertiser 205 and/or third party, such as a researcher or surveyor, may project recall rates for one or more users or groups of users, which may then be transmitted to the advertising system 140 for use with the management of ad campaigns and/or the delivery of advertisements. Various other components or entities may be used to determine recall rates for one or more users or groups of users.

Recall rates may be estimated, predicted, determined, calculated, projected, forecasted, and/or otherwise identified in various ways. For example, data about a user or group of users' recall of an advertisement display may be collected and/or gathered, such as experimentally or through the use of surveys or other questionnaires completed by the user or group of users. In some systems, the advertising system 140 may construct, administer, and/or collect information from surveys or experiments run to test and gather data about a user's recall rate. For example, a user may be asked, after visiting a web site and/or being exposed to a displayed advertisement, to provide feedback related to the user's ability to recall what was displayed. In other systems, one or more third parties may conduct surveys or research related to user's recall rate which may be used by the inventory management system 250.

Collected data may be reviewed and/or analyzed, such as by the advertising system 140 or third party. Information and/or data about a user or group of users' recall may be analyzed and/or determined, in some cases, as a function of one or more variables, such as length of time exposed to the advertisement, order which the advertisement was displayed, placement of the advertisement, and/or content or images in the advertisement. Information and/or data collected about the user's recall may then be compared, charted, graphed, and/or analyzed in associate with another variable, such as length of time the user was exposed to the advertisement.

Recall rates, trends, patterns, and/or information may be determined, identified, calculated, and/or otherwise generated from the analyzed data. For example, multiple data points representing a user or group of users' recall as compared with another variable, such as time exposed to an advertisement, may be gathered and plotted on a graph. The advertising system 140 and/or a third party may then use this information to determine, such as using a computer-implemented algorithm or software, a best-fit curve or line (“best-fit curve”) which may be indicative of a user's or group of users' recall rate for any given length of time of display. The advertising system 140 and/or the third party may gather data and determine a best-fit curve or line continuously, at designated intervals, and/or at designated events such as every time an impression is served to a user 215.

In some systems, the recall rate of a user may be compared to a length of time of display of the advertisement to determine a best-fit curve or line. In other systems, the recall rate of the user may be compared with a timing or order of display of the advertisement. In other systems, both the length of time of display of the advertisement and the order of the display of the advertisement may be factored into the comparison. For example, separate best-fit curves or lines may be generated for the recall rate of a user compared to a length of time of display of the advertisement for each position or ordered placement of the advertisement, such as having a first best-fit curve for advertisements displayed first, a second best-fit curve or line or advertisements displayed second, and so forth.

In some systems, a best-fit curve or line may be determined for each user individually. This may be useful, for example, where the advertiser has utilized an exchange, such as Yahoo!'s Right Media exchange (RMX). In other systems, a best-fit curve or line may be determined for all users. This may be useful, for example, to reduce a cost or processing power otherwise required for individualized results. In still other systems, a best-fit curve or line may be determined for one or more of a subset of users, such as only those users who are male and live in California, which may provide advantages of both. Many other variations are possible.

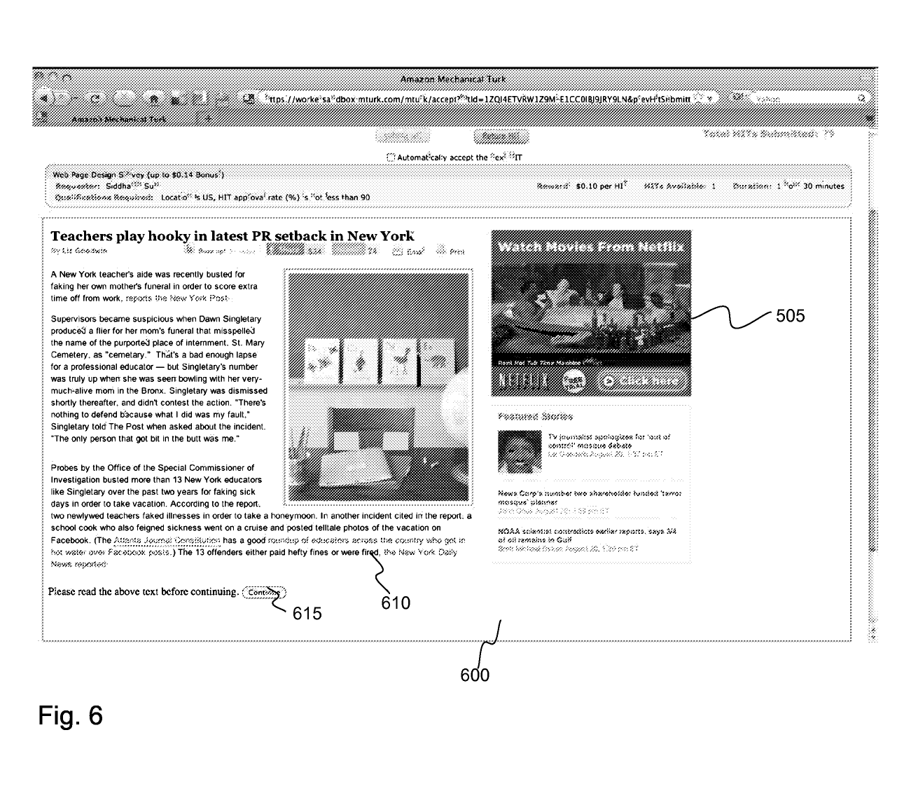

FIGS. 6-9 illustrate the performance and results of an experiment run to determine recall and recognition rates for a group of users living in the United States when viewing an advertisement with other content on a web page (referred to herein as “experiment 1”). These recall and recognition rates, as well as the procedures used to establish and/or determine the recall and recognition rates, may be useful to the advertising system 140 and/or advertisers 205.

Experiment 1 was conducted using Amazon's Mechanical Turk, which is a crowdsourcing website where requesters can post jobs, called human intelligence tasks (HITs), and workers can do those HITs for pay. After a user submits their work for a HIT, requesters review the work and accept it or reject it. Mechanical Turk was originally built for humans to do tasks that are hard for machines to do, such as extracting data from images, audio transcription and filtering adult content.

HITs can be divided up into assignments, where a turker (user) can only do one assignment of a HIT. Using this and by tracking the IDs of the users who accepted our hits, participant users were only allowed to participate in one experiment, and they were only allowed to do that experiment once. Throughout this experiment, Mechanical Turk API was used to restrict the subject pool to users who live in the United States and who had a high approval rating (over 90%).

As described, the experiment appeared to discover and/or establish a correlation between endogenous (self-determined) time spent on a web page and memory for a display ad on that page. Participant users were recruited from Mechanical Turk by means of a HIT offering a fixed payment in addition to a smaller payment per question answered. To avoid the possibility of collusion, payment was not based on the correctness of answers. The preview page for the HIT consisted of a consent form and instructions indicating that the task involved reading and answering questions about a Web page.

In order to spread out the distribution of reading times, participant users were assigned to conditions in which the article was either short or long. Randomization occurred at the moment the HIT was undertaken, precluding any confound between time of testing and condition assignment. In addition to article length, random assignment also governed which of two display ads (for either Netflix or Jeep) and which of two articles (about either schoolteachers or an oil spill) would be shown. Manipulation of ad and article was undertaken towards the aim of generalizable results under the methodological standard of representative design.

In the task, participants were shown high-resolution screen captures of web pages 600, as shown in FIG. 6. In all conditions, the assigned display ad 605 appeared next to the text 610. The image of each web page was chosen to be 600 pixels high. This height was chosen because 99% of screens on the web are able to show at least 600 pixels in height, ensuring that the user could see the pages and the display ad in their entirety without scrolling and that the display ad was always in view.

After reading the first page of their assigned article, participant users clicked a button 615 to continue on to a second page, which featured the same display ad as the first page. In the short condition, the second page contained only one sentence, while in the long condition the text extended to the bottom of the second page. After the participant users read both pages at their own pace, they proceeded on to the questionnaire and were unable to direct the browser to display the ad or article again.

The questionnaire first presented two, five-alternative multiple choice reading comprehension questions. After that, it presented one unaided recall question: “Which advertisements, if any, did you see on the page during the experiment? Type the name of any advertisers here if you can remember seeing their ads on the last page, or indicate that you are unable to remember any.” On a subsequent page, participants were asked “Did you see the following advertisement during this HIT?”, accompanied by a picture of the Netflix ad, and were the presented the same question for the Jeep ad. Participant users were shown only one of these two ads in the experiment, making the other ad a lure which is useful for establishing the false alarm rate. After submitting, the task was completed and answers could not be changed.

Before proceeding with the analysis, the initial sample of 479 was reduced to the inner 98% of reading times to eliminate outliers, reducing the sample by 10, after which 16 participants (4.6%) were excluded for answering both reading comprehension questions incorrectly, leaving a sample of 453 participants with a mean reading time of 123 seconds. The length manipulation was effective in spreading out reading times as reflected by the conditional means (143 and 103 in the long and short conditions) and the interquartile ranges: the 75^{th} percentiles were 181 and 125 seconds and the 25^{th} percentiles were 96 and 72 seconds.

Each participant users' questionnaire responses were coded as four binary items. The first two binary items coded whether the unaided recall question mentioned the two advertisements. The latter two binary items coded the pictorial recognition task.

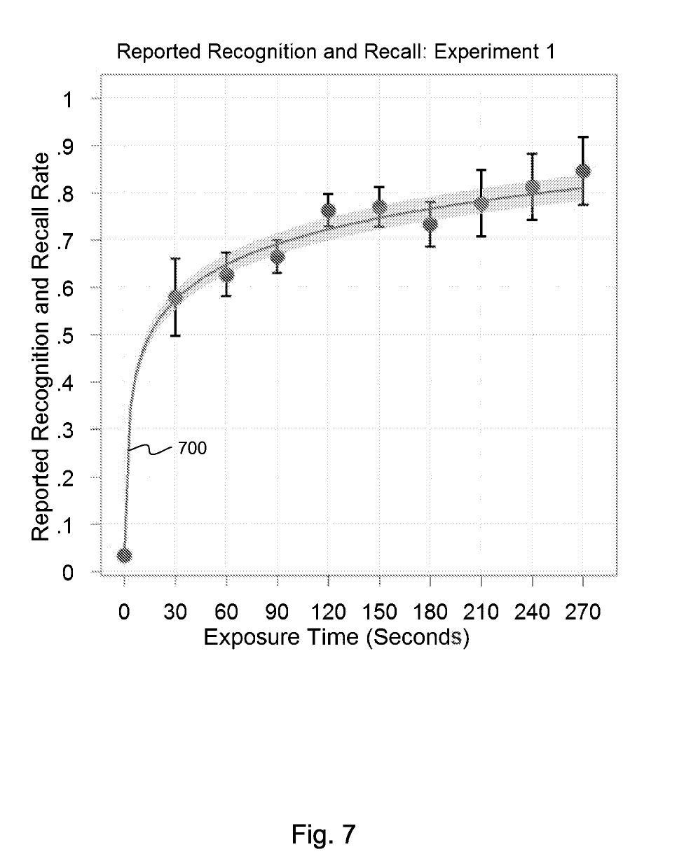

FIG. 7 shows the result of plotting all of this data. The false positive data contributes to the point on the x-axis corresponding to 0 seconds of exposure time. The rest of the data contribute to points on the x-axis with an exposure time strictly greater than 0. FIG. 7 also shows the result of fitting a curve 700 of the form y=a+b log(x+c) to the data along with the 95% confidence interval, where x is the reading time and a; b and c are free parameters. Previous psychological studies on memory have found that memory rates are well described by functions of this form. To indicate the quality of the fit, we also plot the average rate of recognition and recall binned at 30 second intervals. There were 10 responses that took over 270 seconds. They were excluded from the plot because so little data in that time range was received that the error around the mean recognition and recall rate may be quite large.

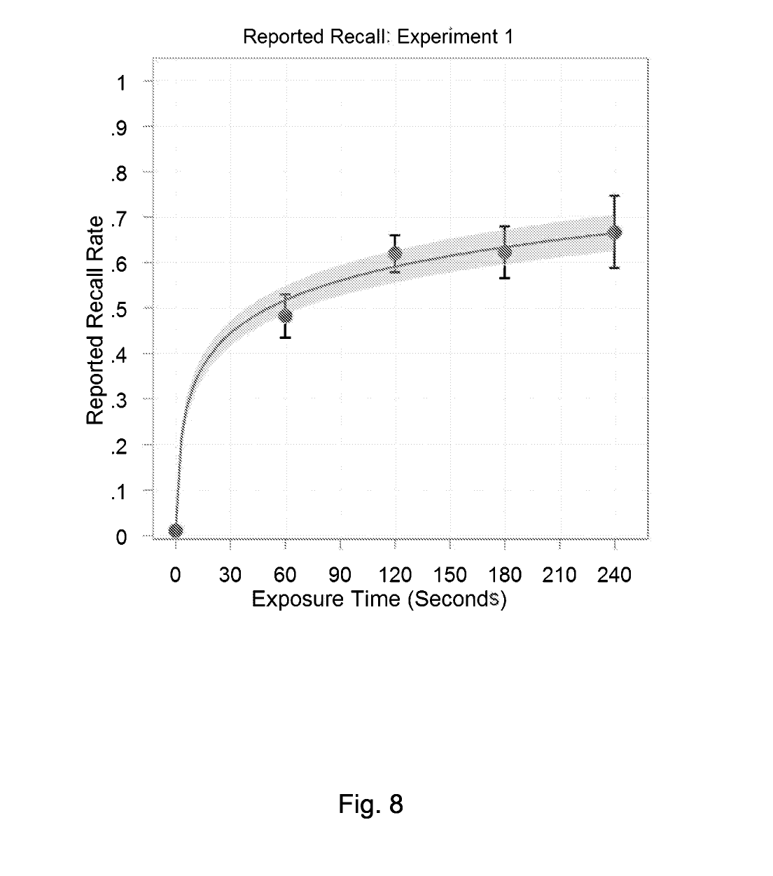

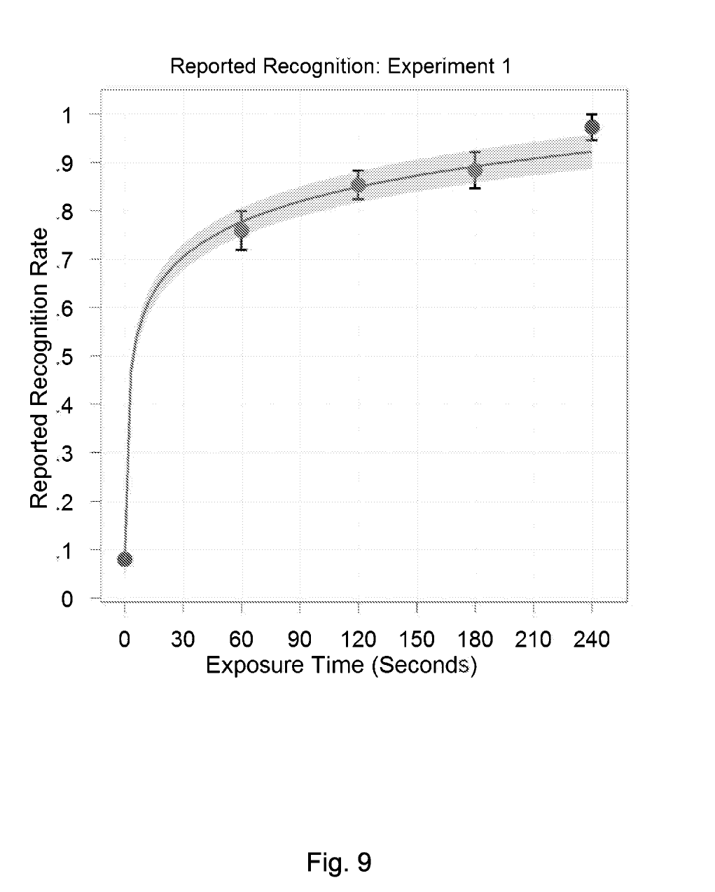

FIGS. 8 and 9 show similar type of plots as in FIG. 7, except with the recall and recognition data is separated. The same functional form may be fit, although with different parameters. Again, to indicate the quality of the fit, we also plot the mean recognition or recall rate. Since these plots each have half of the data shown in FIG. 7 the mean recall and recognition rates are binned in 60 second intervals.

There are a few trends that emerge from examination of FIGS. 8 and 9. First, if one compares FIG. 8 to FIG. 9, it may appear that unaided recall may be harder then recognition yet the unaided recall rate is still quite high over a long range of exposure times, roughly 50% or more with 60 seconds or more of exposure. Also, since the binned means lie so close to the curve that was fit to the data, it appears that the logarithmic function described above describes the data very well. Finally, for both the recall, recognition and combined measures there is a sharp increase from the false positive rate at 0 seconds to 30 seconds. This suggests that the first few seconds of ad exposure may matter most.

FIGS. 7-9 also appear to show that the more time the participant spent reading, the higher the recall and recognition rates. In this experiment, the exposure time of the advertisement was determined by the participant users' reading time.

While this experiment was posted as a HIT on the Mechanical Turk and workers were used as our experimental participants, it should be appreciated that a similar procedure or process could be initiated, conducted, and/or otherwise performed by the advertising system 140 and/or various other components, and may be performed for example, anytime before, during, or after a user's interaction with a content provider, content, an advertisement, and/or the advertising system 140.

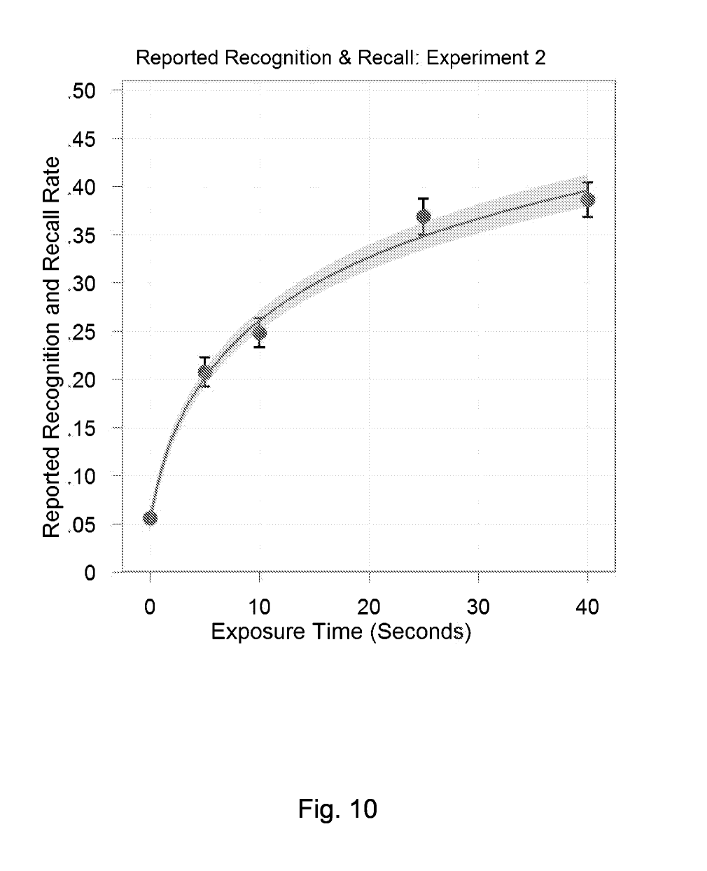

FIGS. 10-14 illustrate the performance and results of an experiment run to determine recall and recognition rates for a group of users living in the United States when viewing an advertisement with other content on a web page (referred to as “experiment 2”). In experiment 2, an exposure time was externally imposed on the participant, which allowed a determination of whether there was a causal link between the time of ad exposure and recall and recognition rates.

Whereas in experiment 1, ad exposure time was roughly equivalent to reading time, experiment 2 manipulated exposure time exogenously to estimate the causal effect of ad exposure time on memory. This was accomplished by displaying ads for a pre-determined number of seconds while people are reading and then having them disappear from view.

Participant users were again drawn from Amazon Mechanical Turk. Instructions again indicated that the task involved reading and answering questions about a Web page. Participant users were again paid a flat rate for completing the experiment, plus a specified amount per question answered. The article used is depicted in FIG. 6. Participant users were randomly assigned into one of four treatments which governed how long they were exposed to the display ad. Simultaneous with the loading of the article, an ad was displayed, depending on condition, for either 5, 10, 25, or 40 seconds. These initial advertisements were then replaced with second ads, which were displayed for 25, 40, 5, or 10 seconds in the respective conditions. After the display time for the second ad expired it was replaced with a white rectangle, giving the appearance of it disappearing altogether. Data collection proceeded in two waves, one comprising 300 subjects that randomly assigned participants to the first and fourth conditions, and the latter one randomly assigning 250 individuals to the second and third conditions. Within the four conditions, participant users were randomly assigned to see the Netflix ad before the Jeep ad or vice versa, resulting in a 2×4 design.

To stabilize forgetting time across participant users, the reading task was followed by a buffer task in which participants played a game for an amount of time that depended on condition. Tetris, a visual game consisting of primary shapes, was chosen to avoid ad-specific linguistic memory interference. The game was rendered in black and white to reduce visual memory interference with the colors present in the ads. Buffer task duration was calculated to equalize forgetting time for the average participant in each condition and ranged between 20 and 55 seconds. After the buffer task time expired, participant users were automatically forwarded to the questionnaire, and were not able to exit the game early.

In the questionnaire phase, the same two, five-alternative multiple choice reading comprehension questions were asked followed by the same unaided recall question as in experiment 1. A subsequent page presented four recognition questions with textual cues of the form “Did you see an Netflix ad?”, with Jeep, American Express and Avis as the other advertisers. Netflix and Jeep were the “target” advertisers whose ads that participants were indeed shown, while American Express and Avis were “lure” advertisers, whose advertisements were not shown. Inclusion of lures was particularly relevant for the next four questions, which were recognition questions with pictorial cues asking “Did you see this ad”? and showing the two ads from the experiment and two lures. The lures were chosen for bearing a strong visual resemblance to the targets. For example, the Avis lure is primarily red, much like the Netflix ad and the American Express ad has a very similar color scheme to the Jeep ad. This enabled the estimation of a false alarm rate.

Before analyzing the effect of exposure on the memory items, 14 participant users (2.5%) were excluded for not completing the task, after which 7 (1.3%) were excluded for answering both reading comprehension questions incorrectly.

Each participant user's data was coded as twelve binary responses. The first four coded mentions of the two target ads and lures from the unaided recall question. The next four were the recognition questions with textual cues, and the final four were the recognition items with pictorial cues (the ads themselves).

Based on reading time estimates from experiment 1, experiment 2 was designed such that about 80% of people would take long enough reading the article that they would be exposed to both ads for the prescribed amounts of time. This estimate turned out to quite accurate as the fastest 20% of readers finished in 51 seconds, and only 50 seconds were needed to see both ads in the longest condition (in which two ads are shown for 10 and 40 seconds). The median reading time was 77 seconds, the 75th percentile was 98 seconds and the 25th percentile was 55 seconds. The purest exogenous analysis would exclude the fastest 20% of readers from all conditions to assure the sample consists only of those who saw both first and second ads for the intended amount of time. However, since even fast readers were likely exposed to at least one ad for the intended amount of time, and since only three out of 12 questions attributable to a participant are tied to each target ad, the questions were dropped, as opposed to the participant users, for which full intended treatment was not received and thus retain 96%, as opposed to 80% of the observations. Doing so may introduce a slight bias, so as a preventive measure, all analyses were run dropping the fastest 20% of users, dropping the affected 4% of observations for which the full treatment was not received, or doing neither. The effect of such filters on derived estimates was negligible. For example, in FIG. 10 after the application of such filters, the average point estimate moved by less than one percentage point, and no estimate moved by as many as two percentage points. Accordingly, in the analyses which follow, we retain the 96% of items for which the intended level of exposure was received.

As shown in FIG. 10, there appears to be a clear increasing trend in the probability of reporting memory of an advertisement as a function of manipulated exposure time, with a log function providing a good fit. The best fitting curve took on the form y=−0.009+0.106 log(x+1.681), where y is the memory response and x is the time of exposure. The basic shape of this curve, which shows the causal effect of exposure time on memory, may shed light on the results of experiment 1. Substituting in the mean reading times from experiment l's two conditions, 143 and 103 seconds, this curve predicts a difference of 3.4 percentage points, a modest difference, not unlike that realized in this range in experiment 1. While the relation in FIG. 10 does not make point predictions about experiment 1 the two curves occupy different ranges, possibly due to the buffer task in experiment 2 and the two impressions delivered in experiment 1 versus one impression delivered in experiment 2—the same basic logarithmic relationship predicts that relative differences in recall and recognition are difficult to attain beyond exposure times of 100 seconds. For this reason, and for the reason that most Web pages are viewed for less than this long, a prudent accounting system may discount or disregard exposure times beyond this threshold.

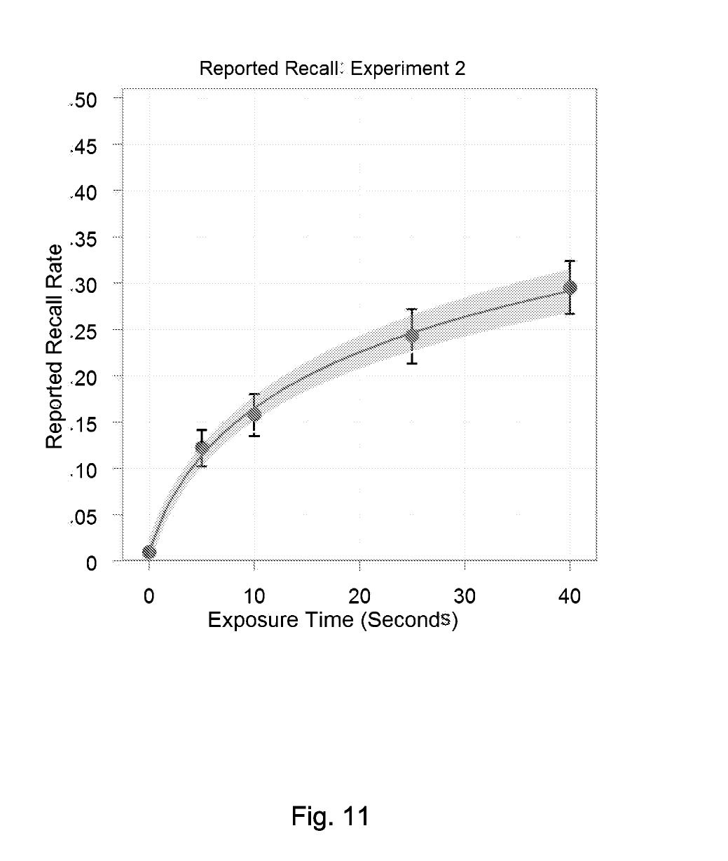

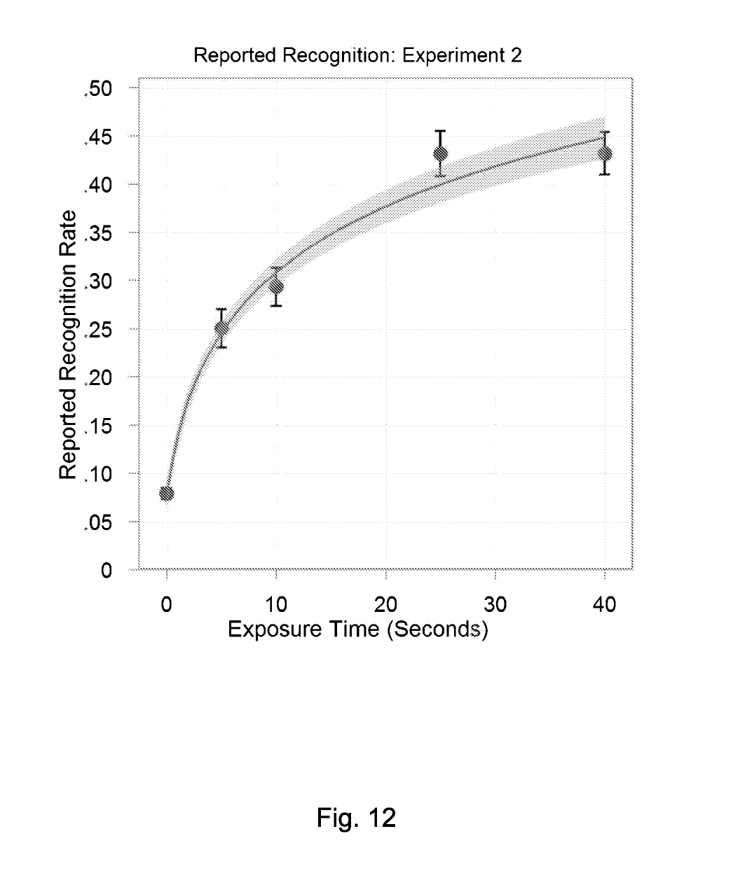

As in experiment 1, decomposing the aggregate curve into subsets of recall and recognition items shows relationships of the same basic shape, with recognition, as is often the case, proving to be an easier task than recall. Free recall and recognition are shown separately in FIGS. 11 and 12. Despite the lures bearing a strong resemblance to the target ads, false alarm rates were low, at 6% on text recognition items, and reaching a maximum of 7.8% for the pictorial recognition items. As expected, the false alarm rate for recall items was 0%. A logistic random effects model, with participants and advertisers as random effects, confirmed that both time of exposure and presentation order to be strong predictors of what is remembered, as treated in the next section.

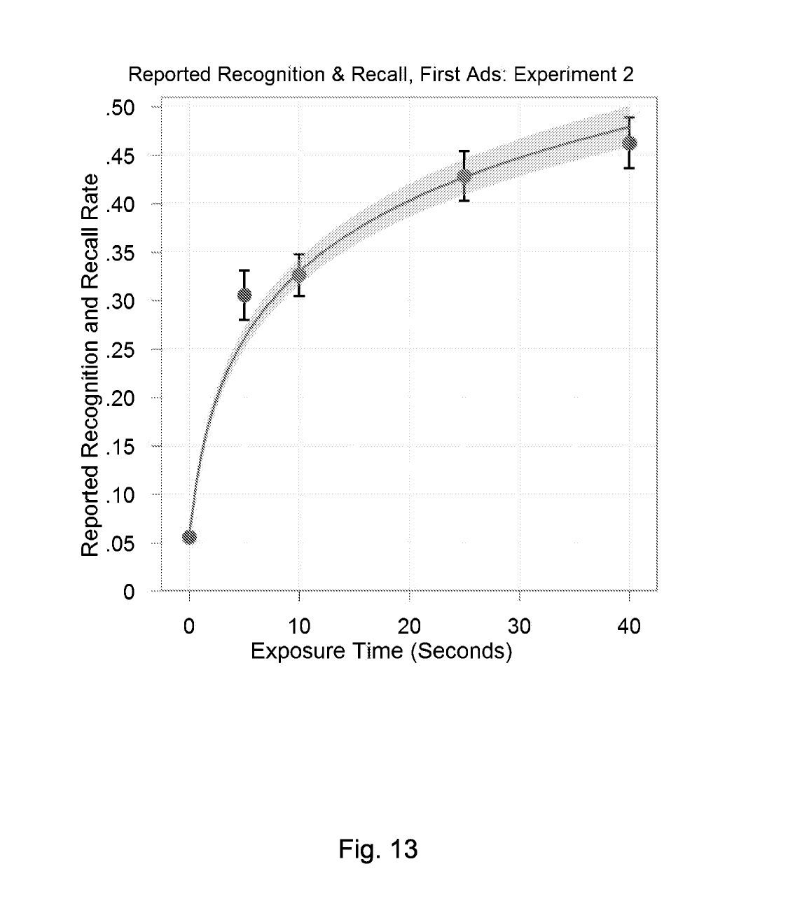

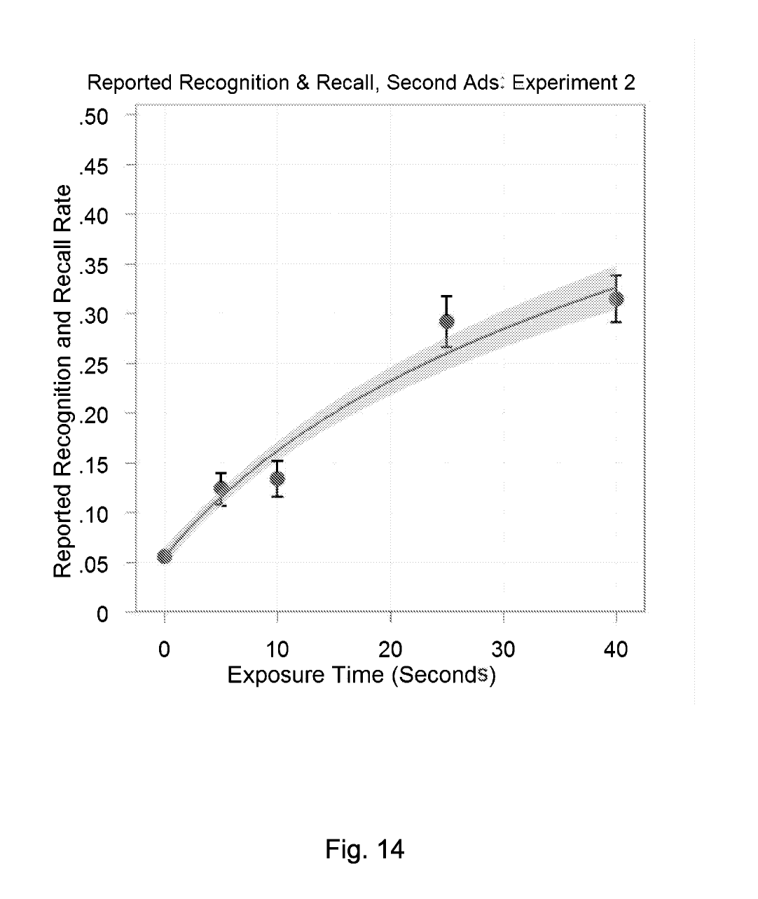

The effect of showing an ad first versus second may also be of interest to a content provider, advertising system 140, and/or advertiser 205. Recall that in experiment 2, users were exposed to an ad for 10 seconds then another for 40 seconds, or vice versa, or they were shown an ad for 5 seconds then another for 25 seconds, or vice versa. In spite of the fact that one might expect that due to their sudden appearance on the page, ads which appear second might have an additional advantage over ads that load with the rest of the page's content, the results indicated that the opposite appears to be true. FIGS. 13 and 14 show the result of plotting the combined recall and recognition for the first and second ads shown. Observe that the recall and recognition rate for the second ad does not have the steep increase at low exposure times as first ads do. Moreover, the combined recognition and recall rate for the second ad shown with 40 seconds of exposure was still 30%.

FIG. 13 shows that the early seconds after the page loads may cause a higher increase in recall and recognition then the later seconds. So, consider a 10 second ad shown second, it appeared after 40 seconds. Also consider a 5 second ad shown second, it appeared after 25 seconds. This may cause the 5 second ad to be seen during a higher recall period of time than the 10 second ad. Thus the recall of the 5 second ad may be slightly inflated relative to the 10 second ad. One can make a symmetric argument which shows that the recall and recognition of the second ad may also be slightly inflated relative to a 40 second ad shown second. Despite this fact, FIG. 13 still shows the first ad has a higher recall and recognition rate then the second. FIG. 13 also shows that 5-10 seconds of exposure of the first ad shown is roughly equivalent to 40 seconds of exposure of the second ad shown. From an advertisers perspective, having an ad shown second appears less valuable the being shown first. Nonetheless, in either case, increasing the exposure time appears to add value.

Experiments 1 and 2, and the performance and results shown in FIGS. 6-14, illustrate a causal link between exposure time on ad recall and ad recognition. More specifically, ad recognition and recall may increase as exposure time increases, with the steepest effect occurring for low values of exposure time. In addition, experiment 2 illustrates that an order of placement of the advertisements may play a factor in recall and recognition rates, as the first ad shown has a steep increase of recognition and recall in the first few seconds, but both the first and second ad shown benefit from more exposure time.

Determined and/or calculated recall rates may be used by an advertising system 140 and/or advertisers 205 for various purposes. For example, a recall rate may be used to determine a threshold for displaying an advertisement to a user 215, such as the thresholds discussed in the methods of FIGS. 3-5.

As mentioned, in some systems, a desired recall rate may be identified, such as where an advertiser 205 specified a desired recall rate when creating an ad campaign, or where an advertising system 140 calculates a desired recall rate using one or more other factors such as a budget concern and/or pricing model. Using the desired recall rate in conjunction with gathered and/or analyzed data about past and/or estimated recall rates, an advertisement display duration may be calculated. The advertisement display duration may be determined, for example, through the analysis of the best-fit curves or lines, or other algorithms, for the recall rates or recognition rates for an individual or a group of individuals. For example, a best-fit curve for data about recall rates as a function of time may be calculated and/or determined. The point on the best-fit curve at which the desired recall rate is achieved may correspond to the advertisement display duration. The advertisement display duration may be considered and/or designated as the exposure threshold, which may be used, such as by the methods in FIGS. 3-5, to control and/or determine how long to display an advertisement to a user 215.

In some systems, the optimal length of time may be identified, determined, selected, and/or otherwise chosen by balancing one or more advertiser factors with the recall rate or recognition rate of a user. In some systems, an advertiser may be willing to spend a certain amount of money, but may wish to achieve a certain level of recall or recognition for each unit of payment delivered. In these circumstances, the optimal length of time of an advertisement may be determined through a balancing of economical factors of the advertiser.

For example, an advertiser may specify that they would like achieve as great of a recall rate as possible limited by spending no more than $0.01 per 20% recall rate per impression. An online provider may charge $0.01 for each 10 seconds of an advertisement impression. A best-fit curve or line may present a logarithmic relation between the length of time an advertisement is displayed and the recall rate. For example, data about recall rates may indicate that a recall rate of 30% may be achieved with 10 seconds of display (a 30% recall rate/$0.01), a recall rate of 52% may be achieved with 20 seconds of display (a 26% recall rate/$0.01), a recall rate of 60% may be achieved with 30 seconds of display (a 20% recall rate/$0.01), and a recall rate of 72% may be achieved with 40 seconds of display (an 18% recall rate/$0.01). In this example, the optimal length of time for displaying the advertisement would be 30 seconds, as this would provide the greatest recall rate while spending no more than $0.01 per 20% recall rate per impression.

Other criteria and/or requirements may be specified by an advertiser. For example, an advertiser may specify that they would like achieve as great of a recall rate as possible limited by spending no more than a certain value per recall rate percentage per impression, and with a cap value that they will spend per impression. As another example, an advertiser may specify that they will pay to display an advertisement for at least a certain period of time, and pay for extra time after that specified time so long as the increase in the expected recall rate is greater than or equal to a given value. In one or more of these systems, the actual contract for purchase of advertisement impression time and/or placement may be made on the order of thousands, millions, or more impressions, seconds, and/or units of time. In these are various other ways, recall rates may be used in a determination of an amount of time and/or exposure threshold for displaying an advertisement to a user 215.

Recall rates may additionally or alternatively be used by the advertising system 140 to price advertising opportunities. Pricing models may be developed based on recall rates may provide measures of actual advertiser value, as opposed to impression-based advertising where pricing may be based on an average over a set of items or a noisy measure of value.

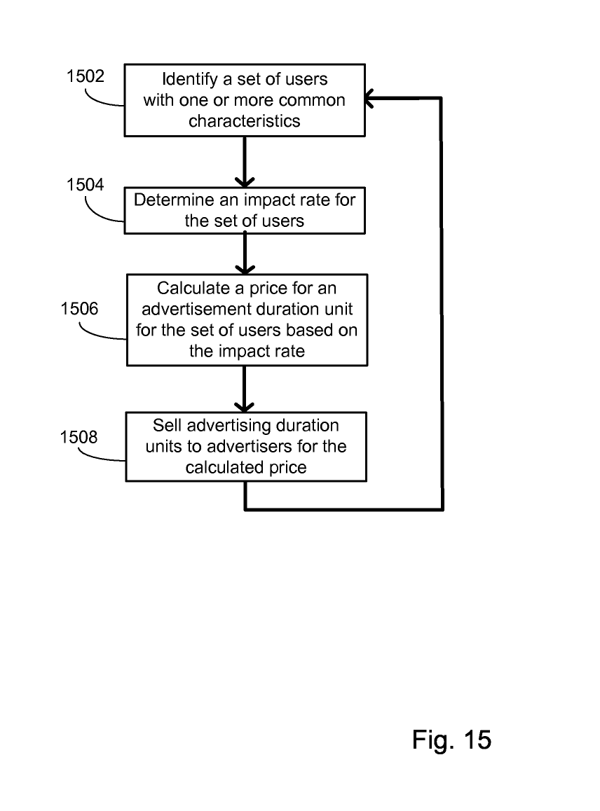

FIG. 15 shows one method of pricing that a content provider and/or advertising system 140 may implement. At block 1502, the advertising system 140 may identify a set of users with one or more common characteristics. For example, the advertising system 140 may identify all males in California under the age of 30. The number of common characteristics and/or specificity of the group may be varied by the advertising system 140 and/or tailored to suit the granularity desired by the content provider, advertiser 205 and/or advertising system 140. In some systems, the set of users may be one user 215, where a separate impact rate may be established for each user 215. Other variations are possible.

At block 1504, an impact rate is determined for the set of users. The impact rate may be a recall rate, recognition rate, and/or various other metrics discussed herein. The impact rate may be calculated or determined in one or more of the ways discussed.

At block 1506, a price is calculated for an advertisement duration unit for the set of users based on the impact rate. The advertisement duration unit may be a unit of time for which an advertisement may be displayed to a user. The advertisement duration unit may, for example, be 1/10^{th} of a second, 1 second, 10 second, 30 seconds, and/or in any other intervals. The price may be based on the impact rate that was determined in block 1504 for the set of users. Different prices may be calculated for different lengths of time and/or different sets of users.

At block 1508, the advertisement duration unit may be sold to an advertiser for the calculated prices. Accordingly, when an ad opportunity for any one of the users 215 from the set of users arises, an advertisement for an advertiser who has purchased an advertisement duration unit for that set of users may be shown to the user for the duration of the advertisement duration unit. This may be performed, for example, in accordance with the method in FIG. 4.

The method of FIG. 15 may then be repeated, with a new set of users being identified in block 1502. In some systems, all users may be categorized into one or more groups, and each group may be subjected to the pricing method of FIG. 15. Other variations are possible.

Pricing models based on recall rates may offer at least three distinct advantages. First, it may permit efficient allocation. When pricing is based on an average, allocating pieces to different buyers is impossible, since the pieces have the same average value. Similarly, with noisy measures of value, more allocative mistakes will be made. Second, pricing based more closely on value mitigates buyer risk, since pricing corresponds more closely to the value actually delivered. Risk matters most in environments with great supply variability like digital advertising. Finally, pricing based on value permits price discrimination—charging advertisers based on the value delivered may let the seller capture a larger fraction of the value generated.

There are numerous systems by which publishers could achieve this. First, publishers could measure how long a user spends with an ad in view, then charge based on this. A second method may involve advertisers buying 30-second “spots”, for example. In this system, even as the user navigated the site, the ad would stay in view for 30 seconds. Moreover, if a user leaves the site before the seconds has expired, publishers could either serve the ad to the user when he or she returns, or prorate the purchase of that spot for the amount of time the user actually spent with the ad in view. Publishers could differentially price spots of different lengths. For example, twenty seconds might sell for one price, forty seconds for just 50% more. Other examples are possible.

Content providers may value and/or price an order of advertisements based on recall rates and/or recognition rates. For example, an advertising system 140 may determine that advertisement duration units of an ad opportunity which provide the greatest recall rates are those at the beginning of an impression, and each successive time interval provides smaller recall rates. Here, the advertising system 140 and/or content provider may price the time intervals according. As an example, a content provider may charge $0.04 for the first 10 seconds of an impression, $0.03 for the second 10 seconds of an impression, $0.02 for the third 10 seconds of an impression, and $0.01 for each of the remaining 10 second impressions.

As another example, advertising time may be charged in accordance with a recall or recognition rate on a continuous basis. For example, suppose that recall increases approximately at the square root of the time in which the advertisement is viewed, a hypothesis which may have been verified either by empirical examination or by polling. The advertising system 140 in this example may assess charges to an advertiser not directly based on time spent in front of the ad but rather by the expected increase in recall or recognition the time confers to the particular user. As such, the advertising system 140 may charge a rate for the display of the advertisement that may vary by the square root of the time in which the advertisement is viewed.

As another example, where the content provider and/or advertising system 140 determines that a first advertisement provides greater recall rates than a second advertisement, and where the second advertisement of an impression providers greater recall rates than a third advertisement of an impression, and so forth, the content provider may price the order of the advertisements accordingly. For example, a content provider may price each 10 second interval of the first advertisement of an impression at $0.03, each 10 second interval of the second advertisement of an impression at $0.02, and each 10 second interval of the third or greater than third advertisement of an impression at $0.01.

In other systems, the content provider and/or advertising system 140 may price time intervals for display of an advertisement based on both the time of the start of the advertisement and the order of the advertisement. This pricing scheme may be guided, for example, by an algorithm or other function or formula which may provide diminishing value for each successive time interval of the same advertisement and diminishing value for the first time interval of each successive advertisement of an impression, though not necessarily a diminishing value for a time interval starting a new advertisement as compared to the last time interval of the previous advertisement. Many other variations are possible.

Additionally or alternatively, recall rates may, for example, be used by an advertiser 205 to determine a budget and/or for strategic advertising purposes. An advertiser 205 may have access to recall rates and/or data about a set of users' recall rates. Advertisers 205 may note differences in pricing of advertising opportunities or impressions for different groups of users. An advertiser 205 may use this information to determine how to allocate advertising resources. Advertisers 205 may utilize the recall rates of each of the differently priced groups of users to maximize, through one or more algorithms, a recall rate and realization or monetization achievable, and may purchase accordingly. These determinations may or may not be performed in conjunction with pricing models and/or tables created by advertising systems 140.

For example, consider an example where the males between 20 and 30 years old in California have a higher profitability for an advertiser 205 or a market generally than males between 40 and 45 in North Dakota. Where advertising opportunities for the first class of users is substantially higher than all others, and where an advertiser 205 has specified that a portion of the advertising impressions they purchase may come from a plurality of different classes of users including this first class of users, the advertiser 205 may increase a purchased supply of advertising opportunities or impressions from the first class of users. Other variations are possible.

Advertisers 205 may similarly use recall rates to purchase ad opportunities which are cheaper but provide the same or similar recall rates for the advertisers. For example, where two sets of users provide the same recall rates and/or expected impact for the advertiser 205, the advertiser may purchase more impressions for the set of users which are associated with the lower cost per impression or advertisement duration unit than the other set of users which have the same or similar recall rates. Other examples and uses of recall rates are possible.

While the above described methods and systems may refer to a comparison and/or determination as to whether one element is greater than or equal to a second element, in some embodiments one or more of these comparisons may be replaced by a comparison and/or determination as to whether one element is greater than a second element. Similarly, comparisons and/or determinations described as being “greater than” may also be replaced with “greater than or equal to.” While the above described methods may refer to a comparison and/or determination as to whether one element is less than or equal to a second element, in some embodiments one or more of these comparisons may be replaced by a comparison and/or determination as to whether one element is less than a second element. Similarly, comparisons and/or determinations described as being “less than” may also be replaced with “less than or equal to.” Comparisons and/or determinations made which require an element to “exceed” a second element may be replaced by comparisons and/or determinations which require an element to “exceed or equal” a second element, and vice versa.

All or a portion of the system may be automatically or manually configured to operate based on a determined accuracy, latency, and/or CPU/memory utilization. For example, threshold values may be determined, estimated, and/or calculated based on a determined accuracy, latency, and/or CPU/memory utilization, as well as other features.

As mentioned the above described systems and/or methods may be part of, conducted by, implemented in, configurations of, employed by, and/or run using any one or more of the advertising system 140, the inventory management system 250, the ad serving system 260, campaign allocator 290, the supply forecaster 295, and/or any of the data in the ad logs 280 or campaign logs 270.

The advertising system 140 and client applications 115, 125A-125N may be one or more computing devices of various kinds, such as the computing device in FIG. 16. FIG. 16 illustrates an embodiment of a general computer system designated 1600. Any of the components from the system 100 may include the computer system 1600, such as the web application 125A, the standalone applications 115, 125B, the mobile application 125N, the advertising system 140, the ad serving system 260, the campaign log 270, the ad log 280, the inventory management system 250, the campaign allocation 290, and/or the supply forecaster 295. The computer system 1600 can include a set of instructions that can be executed to cause the computer system 1600 to perform any one or more of the methods or computer based functions disclosed herein. The computer system 1600 may operate as a standalone device or may be connected, e.g., using a network, to other computer systems or peripheral devices.

In a networked deployment, the computer system 1600 may operate in the capacity of a server or as a client user computer in a server-client user network environment, or as a peer computer system in a peer-to-peer (or distributed) network environment. The computer system 1600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1600 can be implemented using electronic devices that provide voice, video or data communication. Further, while a single computer system 1600 is illustrated, the term “system” shall also be taken to include any collection of systems or sub-systems that individually or jointly execute a set, or multiple sets, of instructions to perform one or more computer functions.

As illustrated in FIG. 16, the computer system 1600 may include a processor 1602, e.g., a central processing unit (CPU), a graphics processing unit (GPU), or both. The processor 1602 may be a component in a variety of systems. For example, the processor 1602 may be part of a standard personal computer or a workstation. The processor 1602 may be one or more general processors, digital signal processors, application specific integrated circuits, field programmable gate arrays, servers, networks, digital circuits, analog circuits, combinations thereof, or other now known or later developed devices for analyzing and processing data. The processor 1602 may implement a software program, such as code generated manually (i.e., programmed).

The computer system 1600 may include a memory 1604 that can communicate via a bus 1608. The memory 1604 may be a main memory, a static memory, or a dynamic memory. The memory 1604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1604 includes a cache or random access memory for the processor 1602. In alternative embodiments, the memory 1604 is separate from the processor 1602, such as a cache memory of a processor, the system memory, or other memory. The memory 1604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1604 is operable to store instructions executable by the processor 1602. The functions, acts or tasks illustrated in the Figures or described herein may be performed by the programmed processor 1602 executing the instructions stored in the memory 1604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1600 may further include a display unit 1610, such as a liquid crystal display (LCD), an organic light emitting diode (OLED), a flat panel display, a solid state display, a cathode ray tube (CRT), a projector, a printer or other now known or later developed display device for outputting determined information. The display 1610 may act as an interface for the user to see the functioning of the processor 1602, or specifically as an interface with the software stored in the memory 1604 or in the drive unit 1616.

Additionally, the computer system 1600 may include an input device 1612 configured to allow a user to interact with any of the components of system 1600. The input device 1612 may be a number pad, a keyboard, or a cursor control device, such as a mouse, or a joystick, touch screen display, remote control or any other device operative to interact with the computer system 1600.

In a particular embodiment, as depicted in FIG. 16, the computer system 1600 may also include a disk or optical drive unit 1616. The disk drive unit 1616 may include a computer-readable medium 1622 in which one or more sets of instructions 1624, e.g. software, can be embedded. Further, the instructions 1624 may embody one or more of the methods or logic as described herein. In a particular embodiment, the instructions 1624 may reside completely, or at least partially, within the memory 1604 and/or within the processor 1602 during execution by the computer system 1600. The memory 1604 and the processor 1602 also may include computer-readable media as discussed above.

The present disclosure contemplates a computer-readable medium that includes instructions 1624 or receives and executes instructions 1624 responsive to a propagated signal so that a device connected to a network 1626 can communicate voice, video, audio, images or any other data over the network 1626. Further, the instructions 1624 may be transmitted or received over the network 1626 via a communication port or interface 1620, and/or using a bus 1608. The communication port or interface 1620 may be a part of the processor 1602 or may be a separate component. The communication port 1620 may be created in software or may be a physical connection in hardware. The communication port 1620 may be configured to connect with a network 1626, external media, the display 1610, or any other components in system 1600, or combinations thereof. The connection with the network 1626 may be a physical connection, such as a wired Ethernet connection or may be established wirelessly as discussed below. Likewise, the additional connections with other components of the system 1600 may be physical connections or may be established wirelessly. The network 1626 may alternatively be directly connected to the bus 1608.

The network 1626 may include wired networks, wireless networks, or combinations thereof. The wireless network may be a cellular telephone network, an 802.11, 802.16, 802.20, or WiMax network. Further, the network 1626 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the Figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A computer-implemented method of serving advertisements, comprising:
identifying a first advertising opportunity for a user, the first advertising opportunity comprising an opportunity to display an advertisement to the user;
determining a threshold exposure value;
serving the advertisement to the user during the first advertising opportunity;
tracking, through the use of at least one processor, an exposure duration, the exposure duration representing a total length of time that the advertisement is displayed to the user;
comparing, through the use of the at least one processor, the exposure duration to the threshold exposure value;
identifying a second advertising opportunity for the user;
serving the advertisement to the user during the second advertising opportunity when the exposure duration is less than the threshold exposure value, and not serving the advertisement to the user during the second advertising opportunity when the exposure duration is not less than the threshold exposure value.

2. The computer-implemented method of claim 1, wherein the advertisement is served to the user during all subsequent advertising opportunities for the user arising after the first advertising opportunity until the exposure duration is not less than the threshold exposure value.

3. The computer-implemented method of claim 1, wherein determining the threshold exposure value comprises:
identifying a desired recall rate for the user; and
setting the threshold exposure value equal to an advertisement display duration that corresponds to the desired recall rate for the user.

4. The computer-implemented method of claim 3, further comprising:
gathering data about recall rates as a function of the advertisement display duration; and
calculating a best-fit curve based on the gathered data;
wherein the threshold exposure value is set by identifying the advertisement display duration along the best-fit curve that corresponds to the desired recall rate.

5. The computer-implemented method of claim 3, wherein the desired recall rate is specified by an advertiser associated with the advertisement.

6. The computer-implemented method of claim 1, further comprising storing the tracked exposure duration with information written into a cookie for the user.

7. An advertising system comprising a non-transitory computer readable storage medium having stored therein data representing instructions executable by a programmed processor for managing advertising campaigns, the storage medium comprising:
instructions for identifying a first advertising opportunity for a user, the first advertising opportunity comprising an opportunity to display an advertisement to the user;
instructions for determining a threshold exposure value;
instructions for serving the advertisement to the user during the first advertising opportunity;
instructions for tracking, through the use of at least one processor, an exposure duration, the exposure duration representing a total length of time that the advertisement is displayed to the user;
instructions for comparing, through the use of the at least one processor, the exposure duration to the threshold exposure value;
instructions for identifying a second advertising opportunity for the user;
instructions for serving the advertisement to the user during the second advertising opportunity when the exposure duration is less than the threshold exposure value, and not serving the advertisement to the user during the second advertising opportunity when the exposure duration is not less than the threshold exposure value.

8. The advertising system of claim 7, wherein the advertisement is served to the user during all subsequent advertising opportunities for the user arising after the first advertising opportunity until the exposure duration is not less than the threshold exposure value.

9. The advertising system of claim 7, wherein instructions for determining the threshold exposure value comprise:
instructions for identifying a desired recall rate for the user; and
instructions for setting the threshold exposure value equal to an advertisement display duration that corresponds to the desired recall rate for the user.

10. The advertising system of claim 9, further comprising:
instructions for gathering data about recall rates as a function of the advertisement display duration; and
instructions for calculating a best-fit curve based on the gathered data;
wherein the threshold exposure value is set by identifying the advertisement display duration along the best-fit curve that corresponds to the desired recall rate.

11. The advertising system of claim 9, wherein the desired recall rate is specified by an advertiser associated with the advertisement.

12. The advertising system of claim 11, further comprising instructions for storing the tracked exposure duration with information written into a cookie for the user.

13. A computer-implemented method for serving advertisements, comprising:
identifying a first set of users having a same first user characteristic;
determining a first impact rate for the first set of users; and
calculating, through the use of at least one processor, a first price for a first advertising duration unit based on the first impact rate, the first advertising duration unit representing a period of time during one or more advertising opportunities for one of the first set of users that an advertisement will be displayed to the user.

14. The computer-implemented method of claim 13, wherein the first impact rate for the first set of users represents an average rate as a function of time that the first set of users are able to recall or recognize an advertisement after the advertisement has been displayed to one of the first set of users.

15. The computer-implemented method of claim 13, wherein an advertising opportunity for one of the first set of users comprises a plurality of advertising duration units arranged in an order of display.

16. The computer-implemented method of claim 15, wherein the calculated price of the advertising duration units is further based on the order of display.

17. The computer-implemented method of claim 13, further comprising selling the advertising duration unit at the calculated price.

18. The computer-implemented method of claim 13, wherein an advertisement for an advertiser purchasing an advertisement duration unit is served to one of the first set of users for the period of time equal to the advertising duration unit.

19. The computer-implemented method of claim 18, wherein the served advertisement fills a plurality of advertising opportunities for the user until the advertisement has been displayed for the period of time equal to the advertising duration unit.

20. The computer-implemented method of claim 13, further comprising:
identifying a second set of users having a same second user characteristic;
determining a second impact rate for the second set of users, the second impact rate being different than the first impact rate; and
calculating a second price for a second advertising duration unit based on the second impact rate, the second advertising duration unit representing a period of time during an advertising opportunity for one of the second set of users that an advertisement will be displayed to the user, the price of the second advertising duration unit being different than the price of the first advertising duration unit.
